(19) United States
(12) Patent Application Publication
(10) Pub. No.: US 2026/0048991 A1
(43) Pub. Date: Feb. 19, 2026

(54) FILM SYSTEMS AND METHODS FOR GEL CASTING AND HANDLING IN AEROGEL PRODUCTION

(71) Applicant: CARDINAL CG COMPANY, Eden Prairie, MN (US)

(72) Inventors: Kellen C. Kitzman, Verona, WI (US); Mohammad Arifuzzaman, Middleton, WI (US)

(21) Appl. No.: 19/301,582

(22) Filed: Aug. 15, 2025

Related U.S. Application Data
(60) Provisional application No. 63/683,937, filed on Aug. 16, 2024.

(51) Int. Cl. C01B 33/158

(52) U.S. Cl. CPC C01B 33/1585

(57) ABSTRACT

The invention provides an aerogel production assembly that includes a mold with a mold base defined by a casting substrate, where the casting substrate includes a film. The invention also provides an aerogel production method that involves filling such a mold with a wet gel precursor solution. In other embodiments, the invention provides an aerogel production assembly that includes a film and a film handling system. In still other embodiments, the invention provides an aerogel production assembly that includes an advantageous aging clamp mechanism. Further, some embodiments of the invention provide an aerogel production method that involves a wet gel sheet casted to a casting substrate, where the casting substrate includes a film, and the method includes both peeling the film off the wet gel sheet and conveying the wet gel sheet onto a drying substrate.

### RELATED APPLICATIONS

This application claims priority to U.S. Provisional Patent Application No. 63/683,937, filed Aug. 16, 2024, the contents of which are incorporated herein by reference.

### TECHNICAL FIELD

The present disclosure relates generally to equipment and methods for producing aerogel. More particularly, this disclosure relates to equipment and methods for casting, handling, and aging wet gel in the production of aerogel.

### BACKGROUND

Aerogel is a known insulation material. In some cases, aerogel has been provided in granular, particulate form. In other cases, aerogel has been provided in sheet form.

Aerogel can be formed by sol-gel processes in which a solution is provided in a mold and aged to form a wet gel. This type of casting method can be used to form wet gel sheets. The resulting wet gel can then be solvent exchanged and dried to form an aerogel.

It is desirable to handle wet gel sheets carefully. If wet gel sheets are damaged during handling, it may render them un-useable, depending upon the extent or nature of the damage. Moreover, if a wet gel sheet is damaged during handling, the resulting aerogel sheet may exhibit cracks or other damage, which may propagate or be otherwise exacerbated by further processing of the aerogel sheet.

Thus, in the production of aerogel, it would be desirable to provide methods and equipment for casting wet gel sheets. It would also be desirable to provide methods and equipment for handling wet gel sheets. Further, it would be desirable to provide methods and equipment for aging wet gel sheets. It would be particularly desirable to provide methods and equipment that can facilitate such casting, handling, and aging while eliminating or reducing any resulting damage.

### SUMMARY

In certain embodiments, the invention provides an aerogel production method that includes filling a mold with a solution. In the present method embodiments, the mold includes a mold base defined by a casting substrate, and the casting substrate comprises a film.

Some embodiments of the invention provide an aerogel production assembly that includes a mold with a mold base defined by a casting substrate. In these assembly embodiments, the casting substrate comprises a film.

Certain embodiments of the invention provide an aerogel production assembly comprising a film and a film handling system. The film is configured to serve as a casting substrate. Preferably, the film handling system is configured to provide the film at a filling station of the aerogel production assembly.

Certain embodiments of the invention provide an aerogel production assembly that includes an aging clamp mechanism. In these assembly embodiments, the aging clamp mechanism is configured to deliver clamping force to a batch of molds. Methods of operating such an aging clamp mechanism are also provided.

In certain embodiments, the invention provides an aerogel production method that includes a wet gel sheet casted to a casting substrate. In the present method embodiments, the casting substrate includes (e.g., is) a film, and the method includes peeling the film off the wet gel sheet.

The details of one or more examples are set forth in the accompanying drawings and the description below. Other features, objects, and advantages will be apparent to skilled artisans given the present descriptions, drawings, and claims.

### BRIEF DESCRIPTION OF DRAWINGS

FIG. 1 is a schematic side view of a wet gel casting system in accordance with certain embodiments of the present invention.

FIG. 2 is a schematic side view of a wet gel casting system in accordance with another embodiment of the invention.

FIG. 3A is a schematic side view of a clamp mechanism for aging wet gel in molds according to certain embodiments of the invention.

FIG. 3B is a schematic side view of a clamp mechanism for aging wet gel in molds according to certain embodiments of the invention.

FIG. 4 is a schematic side view of a system for handling a wet gel sheet in accordance with certain embodiments of the invention, with the system shown at one stage of operation.

FIG. 5 is another schematic side view of the system of FIG. 4, with the system shown at another stage of operation.

FIG. 6 is still another schematic side view of the system of FIG. 4, with the system shown at still another stage of operation.

FIG. 7A is a side view of a mold press in accordance with certain embodiments of the present invention.

FIG. 7B is a top view of the mold press of FIGS. 7A.

FIG. 7C is a back view of the mold press of FIGS. 7A-7B.

FIG. 7D is a cross-section of the back view of the mold press of FIGS. 7A-7C.

FIG. 7E is a schematic side view of a path of film travel for the mold press of FIGS. 7A-7D.

FIG. 8A is a perspective view of a wet gel removal device in accordance with certain embodiments of the present invention.

FIG. 8B is a side view of the wet gel removal device of FIG. 8A.

FIG. 9 is a flow chart depicting an aerogel production method in accordance with certain embodiments of the present invention.

FIG. 10 is a flow chart depicting an aerogel production method in accordance with certain embodiments of the present invention.

FIG. 11 is a flow chart depicting a method of removing a casting substrate from a wet gel sheet in accordance with certain embodiments of the present invention.

FIG. 12 is a flow chart depicting an aerogel production method in accordance with certain embodiments of the present invention.

### DETAILED DESCRIPTION

The following detailed description is to be read with reference to the drawings, in which like elements in different drawings have like reference numerals. The drawings, which are not necessarily to scale, depict selected embodiments and are not intended to limit the scope of the invention. Skilled artisans will recognize that the examples provided herein have many useful alternatives that fall within the scope of the invention.

In certain embodiments, the invention provides an aerogel production assembly comprising a mold 100 with a mold base defined by a casting substrate 50. Preferably, the casting substrate comprises (e.g., is) a film 55. The illustrated film 55 is a flexible film, such as a flexible polymer film, which preferably is capable of being wound (e.g., about a reel).

In one example, the film 55 is polyethylene terephthalate (PET). Suitable PET films are commercially available under the tradename Mylar from Mylar Specialty Films through its distributor Tekra, LLC (New Berlin, Wisconsin, U.S.A.). Various polyester films may also be used. Another example is fluoropolymer film, such as polytetrafluoroethylene (PTFE). Suitable fluoropolymer films are commercially available under the tradename Teflon from The Chemours Company (Wilmington, Delaware, U.S.A.).

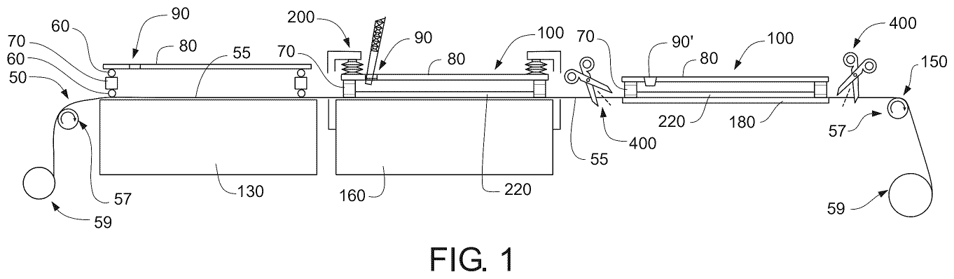

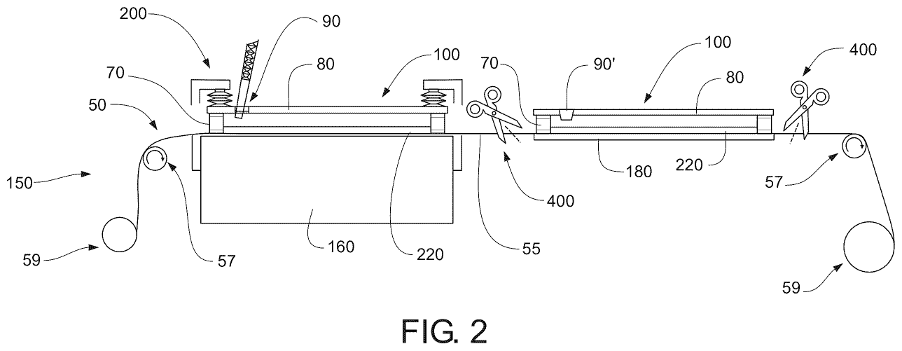

Preferably, the mold 100 includes a mold lid 80 extending over a mold cavity of the mold. This can optionally be the case for any embodiment of the present disclosure that involves the mold 100. This is shown in the non-limiting examples of FIGS. 1 and 2. While not required, the illustrated mold 100 includes four sidewalls defined by a mold spacer 70, which is positioned removably on top of the casting substrate 50. In other cases, four sidewalls of the mold are collectively defined by two or more bodies. Furthermore, the mold spacer 70 can be provided in various shapes, so it is not required to define four sidewalls.

The film 55 preferably has a thickness of less than 20 mils (i.e., less than 0.02 inch), such as about 10 mils (i.e., about 0.01 inch).

At certain times during aerogel production, the mold 100 contains a solution 220. This can be appreciated by referring to FIGS. 1 and 2. The solution 220 is a precursor for wet gel, such as a precursor for silica wet gel. Preferably, the solution (or “wet gel precursor”) includes water. Various solutions can be used, depending on the type of aerogel and properties desired. Some non-limiting examples of silica wet gel precursors are disclosed in U.S. patent application Ser. Nos. 18/636,553 and 18/636,591 and 18/636,411 and 18/636,421 and 18/636,464 and 18/636,497 and 18/636,681 and 18/636,715 and 18/637,947 and 18/637,975 and 18/638,006 and 18/638,201 and 18/637,769 and 18/637,850 and 18/637,818 and 18/637,885, the contents of each of which are hereby incorporated by reference. The present invention, however, is not limited to any particular solution/precursor.

Preferably, the mold 100 includes a mold spacer 70 and a mold lid 80 assembled together with (e.g., on) the film 55. If desired, the mold spacer 70 and mold lid 80 can be different portions of a single body. More preferably, though, the mold spacer 70 and the mold lid 80 are two separate bodies. This can optionally be the case for any embodiment of the present disclosure that involves the mold spacer 70 and the mold lid 80. This can provide certain processing efficiencies and technical advantages, such as enabling easier separation of a resulting wet gel sheet from the casting substrate 50. The mold spacer 70 defines sidewalls of the mold 100.

Preferably, the film 55, the mold spacer 70, and the mold lid 80 (including any sealed filling port in the mold lid) collectively seal, against evaporation, the solution 220 inside the mold 100.

In the embodiments of FIGS. 1 and 2, the mold 100 is positioned at a filling position (see second station in FIG. 1; see first station in FIG. 2), the solution 220 is on top of the film 55, and the film is on top of a surface plate 160. In the illustrated embodiments, the solution 220 is in contact with the film 55, and the film is in contact with the surface plate 160. In one non-limiting example, the surface plate 160 is a granite surface plate. In other cases, another stone material, glass, metal (e.g., steel), polymer, wood, or composite is used for the surface plate.

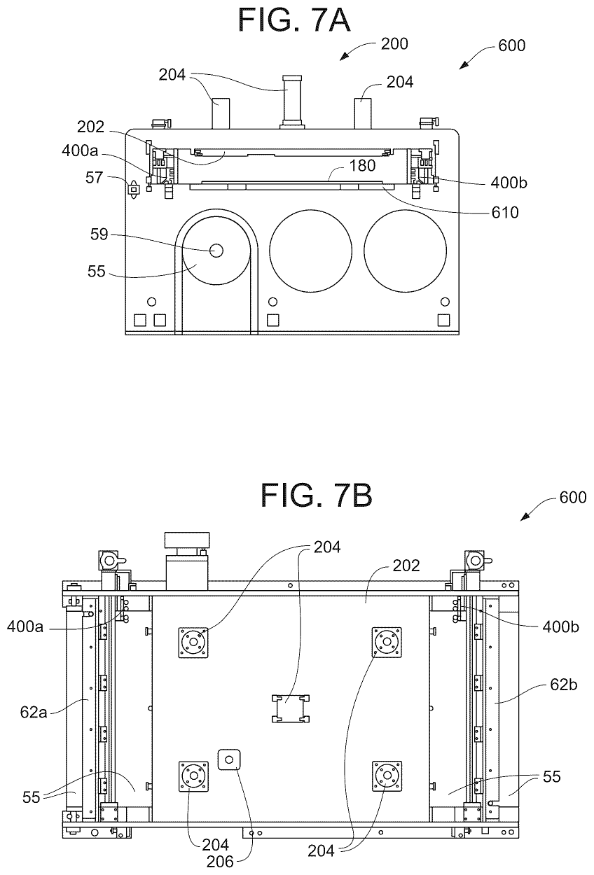

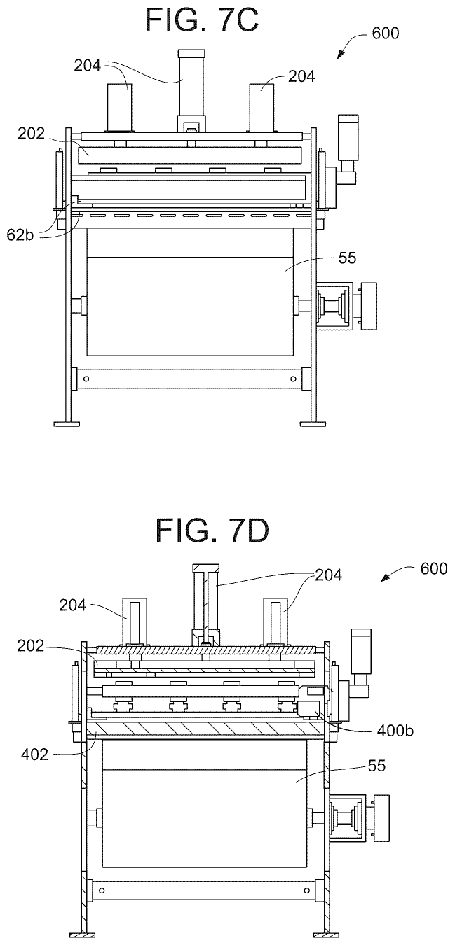

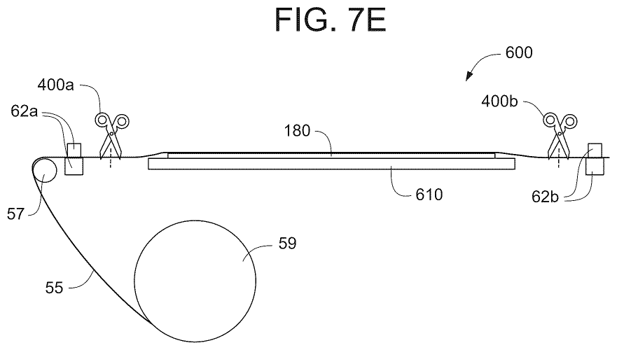

In one or more embodiments with reference to FIGS. 7A-7E, the invention provides an aerogel production assembly comprising a mold press 600. The mold 100 may be positioned at a filling position within the mold press 600 such that the film 55 is on top of a rigid substrate 180, such as a glass sheet. The rigid substrate 180 may be positioned on a substrate support 610 (e.g., a bottom platen) in the mold press 600.

The illustrated mold lid 80 includes a filling port 90, which is configured to be accessed to fill the mold 100 with solution 220. If desired, after accessing the port 90 to fill the mold 100 with solution 220, the port can be sealed, e.g., with a plug 90′. To fill the mold 100 with the solution 220, a nozzle, hose, or other sol-delivery device can be inserted into (or otherwise operably coupled with) the port 90, as shown in FIGS. 1 and 2. In such cases, the method involves flowing the solution 220 through the filling port 90 to deliver the solution into the mold 100.

In some embodiments, the aerogel production assembly includes a filling clamp mechanism 200. When provided, the filling clamp mechanism 200 is configured to clamp the mold lid 80, the mold spacer 70, and the film 55. Preferably, the filling clamp mechanism 200 is configured to clamp the mold lid 80, the mold spacer 70, and the film 55 by applying downward force onto the mold lid, e.g., onto a perimeter area thereof. The perimeter area of the mold lid 80 is directly above the mold spacer 70.

The optional filling clamp mechanism 200 may include one or more springs, cylinders, pistons, and/or other clamp components configured to clamp the mold lid 80, the mold spacer 70, and the film 55, e.g., downwardly against a surface plate 160 and/or a rigid substrate 180. In some cases, the surface plate 160 is a granite surface plate. It is to be appreciated, however, that various other materials (e.g., other stone materials, glass, metal, polymer, wood, or composites) can alternatively be used.

In one or more embodiments with reference to FIGS. 7A-7D, a filling clamp mechanism 200 comprises a press 202 and a plurality of pistons 204. In such embodiments, the press 202 can optionally be configured to carry a mold lid 80 such that the filling clamp mechanism applies the mold lid 80 to the mold spacer 70 and applies force (e.g., downward force) to clamp the mold lid, the mold spacer, and the film 55. For example, a mold lid 80 may be loaded onto the press 202 such that the mold lid is carried alongside a downwardly-facing surface of the press. The press 202 may optionally have one or more ledges (or “lips”) configured to slidably receive the mold lid 80 and carry the mold lid alongside the downwardly-facing surface of the press 202. The one or more ledges may be in contact with the edges of the mold lid 80. In such cases, the filling clamp mechanism 200 is configured to release the mold lid 80 from the one or more ledges of the press 202. For example, such one or more ledges preferably are configured to disengage the mold lid 80 (e.g., move in a direction away from the mold lid 80) such that edges of the mold lid slip off the one or more ledges of the press. In other embodiments, instead of loading the mold lid 80 onto the press 202, for application via the filling clamp mechanism, the mold lid 80 may initially be seated on the mold spacer 70, and the press 202 may thereafter be operated to apply pressure to the assembled mold 100 thereby sealing the mold lid 80 to the mold spacer 70. With reference to the mold press 600 illustrated in FIGS. 7A-7E, the film 55 may be positioned on top of a rigid substrate 180 while the rigid substrate 180 rests on top of a substrate support 610 (e.g., a bottom platen) of the mold press. When provided, the rigid substrate 180 preferably is a glass sheet.

When solution 220 is delivered into the mold 100, a surface plate 160 and/or rigid substrate 180 preferably supports the film 55 as well as the solution 220 on top of the film. Thus, a surface plate 160 or rigid substrate 180 preferably has an upper surface that contacts the film 55 when the solution 220 is delivered into the mold 100. In such cases, the upper surface of the surface plate 160 or rigid substrate 180 preferably is continuous, flat, and flush with a horizontal plane extending along an entirety of the upper surface area that contacts the bottom of the film 55.

In other set-ups, the filling clamp mechanism is omitted, the mold spacer 70 is pressed (e.g., manually, robotically, and/or by gravity) onto the film 55 to seal thereto, and the mold lid 80 is pressed onto the mold spacer (in cases where they are separate bodies) so as to seal thereto. In such cases, the adhesion or other seal of the mold spacer 70 to the film 55 preferably can be overcome later when it is desired to remove the mold spacer and the mold lid 80 from the film. In still other set-ups, the mold lid and the mold spacer are different portions of a single body, which is pressed onto the film so as to seal thereto. Again, this adhesion or other seal to the film preferably can be overcome later when it is desired to separate the film from the single body defining both the mold spacer and mold lid. Given the present teaching as a guide, various other useful set-ups will be apparent to a person of ordinary skill in this technology field.

As can be seen in the first two stations of FIG. 1, the mold spacer 70 can be pressed onto the film 55 with a first seal 60 therebetween to facilitate sealing the mold 100. Similarly, in embodiments where the mold lid 80 and the mold spacer 70 are separate bodies, the mold lid can pressed onto the mold spacer with a second seal 60 therebetween to facilitate sealing the mold 100. Preferably, each of the first and second seals 60 is an O-ring, such as an O-ring formed of silicone or another suitable material. Another option is to use first and second beads of sealant for the first and second seals 60. When provided, the first and second beads may comprise curable silicone. Other sealant beads, such polysulphide or polyurethane, may also be suitable.

In the embodiments of FIGS. 1 and 2, the film 55 has opposed first and second end regions that are wound respectively about first and second reels 59. In addition, the illustrated film 55 is in contact with (e.g., is guided along) first and second rotatable rollers 57, which are located between the first and second reels 59. If desired, there may be additional guide rollers or various other roller arrangements, depending upon the details of the desired system. Instead of the rollers 57, it may be possible to simply provide stationary rods, bars, plates, frame members, platens, table portions, or other guides along which the film 55 can slide.

With continued reference to FIGS. 1 and 2, at a later stage in the production process (see third station in FIG. 1; see second station in FIG. 2), the mold 100 preferably is positioned at a transfer position, where the film 55 sits on a rigid substrate 180. In some cases, the rigid substrate 180 comprises a glass sheet. It is to be appreciated, however, that various other rigid substrates can be used, such as polymer or metal substrates.

In certain embodiments, the film 55 sits on a rigid substrate 180 when the mold 100 is positioned at a filling position. One non-limiting example is illustrated in FIGS. 7A-7E. Preferably, the film 55 has opposed leading and trailing end regions. The trailing end region of the film 55 is configured to be wound about a single reel 59. In one or more embodiments, the single reel 59 may serve as a supply reel. The leading end region of the film 55 is configured to extend across an upper surface of a rigid substrate 180, which is located inside the mold press 600. This can be appreciated by referring to FIGS. 7B and 7E. In some embodiments, the method includes unspooling the film 55 from the reel 59 and extending the film 55 across the rigid substrate 180. In some embodiments, a single roller 57 is provided to guide the film 55 as it extends across the rigid substrate 180.

With continued reference to FIGS. 7A-7E, the method may further include clamping the film 55 at one or more locations, e.g., to keep the film stationary on the rigid substrate 180. Preferably, the film 55 is retained in a stationary position during a filling operation (i.e., when filling the mold 100 with solution 220). This can optionally be the case for any embodiment of the present disclosure that involves filling a mold 100 with solution 220. Clamping the film 55 may include operating one or more film brakes. In some embodiments, a first film brake 62a and a second film brake 62b are located respectively on trailing and leading sides of (e.g., respectively behind and ahead of) the rigid substrate 180. Thus, the film 55 preferably can be clamped simultaneously both behind and ahead of the rigid substrate 180. In some embodiments, the method includes unspooling the film 55 from the reel 59, passing the film 55 through a first film brake 62a, extending the film 55 along an upper surface of the rigid substrate 180, and passing the film through a second film brake 62b. Reference is made to the non-limiting example of FIG. 7E. In some embodiments, one or more rollers are further provided to guide the film 55 across the rigid substrate 180. With reference to FIGS. 7A-7E, a single roller 57 is provided to guide the film 55 through a first film brake 62a, before it extends across the rigid substrate 180.

Clamping the first film brake 62a and second film brake 62b may be done sequentially or simultaneously. In one or more embodiments, the first film brake 62a is adjacent a front side of the mold press 600 and the second film brake 62b is adjacent a back side of the mold press.

In one or more embodiments, the method comprises clamping a leading end region of the film 55 with the second film brake 62b, which can optionally be adjacent a back side of the mold press 600, such that the film 55 extends across the rigid substrate 180. Once the film 55 is clamped by the second film brake 62b, the reel 59 can optionally be rotatably reversed to tension the film 55 extending over the rigid substrate 180. This may be helpful for reducing wrinkles and to ensure that the film 55 is smooth across the rigid substrate 180. Once the film 55 is taut, the method can optionally further comprise clamping the film 55 with the first film brake 62a, which can optionally be adjacent a front side of the mold press 600. Thus, the film 55 can be held stationary and taut. Another option is to omit the first film brake 62a and simply maintain tension on the film, if desired, through operation of the reel 59. Furthermore, it may be suitable to simply lay the film over the rigid substrate, i.e., without affirmatively applying tension to the film.

When the rigid substrate 180 is a glass sheet, a variety of known glass types can be used. Examples include soda-lime glass, borosilicate glass, and aluminosilicate glass. In other cases, the rigid substrate is a sheet of polymer, such as polycarbonate, acrylic, or PVC. Other polymer materials can be used.

Glass sheets or other substrates of various sizes can be used as the rigid substrate 180. Commonly, large-area glass sheets are used. For example, the rigid substrate 180 can have a major dimension (e.g., a length or width) of at least about 0.1 meter, preferably at least about 0.5 meter, more preferably at least about 1 meter, or at least about 1.5 meters.

Glass sheets or other substrates of various thicknesses can be used. In some embodiments, the rigid substrate 180 has a thickness of about 1-8 mm. In some cases, it has a thickness of between about 2.3 mm and about 4.8 mm, and more preferably between about 2.5 mm and about 4.8 mm. In one embodiment, the rigid substrate 180 is a glass sheet having a thickness of about 3 mm.

Thus, some embodiments provide an aerogel production method comprising filling a mold 100 with a solution 220, where the mold includes a mold base defined by a casting substrate 50, and the casting substrate comprises (e.g., is) a film 55.

In the present method, when filling the mold 100 with the solution 220, the casting substrate 50 preferably is maintained in a stationary position. This can optionally be the case for any embodiment of the present method. Reference is made to FIGS. 1 and 2. Here, the illustrated mold 100 includes a mold lid 80 extending over a mold cavity that receives the solution 220 when filling the mold with the solution. While not required, the illustrated mold 100 includes four sidewalls defined by a mold spacer 70, which is positioned removably on top of the casting substrate 50. In other cases, four sidewalls of the mold are collectively defined by two or more bodies. In still other cases, a single body defines the mold lid and the mold spacer. Furthermore, the mold spacer 70 can be provided in various shapes, so it is not required to define four sidewalls.

Preferably, the casting substrate 50 is on top of a surface plate 160 and/or rigid substrate 180 when filling the mold with the solution 220. Two non-limiting examples are shown in FIGS. 1 and 2. Here, the surface plate 160 preferably is stationary when filling the mold with the solution 220. This can optionally be the case for any embodiment that includes filling the mold with solution. When provided, the surface plate 160 can optionally be a granite surface plate, as noted above. It is to be appreciated, however, that various other materials (e.g., other stone materials, glass, metal, polymer, wood, or composites) can alternatively be used. When provided, the rigid substrate 180 can optionally be a glass sheet, as noted above. When the rigid substrate 180 is a glass sheet, a variety of known glass types can be used. Examples include soda-lime glass, borosilicate glass, and aluminosilicate glass. In other cases, the rigid substrate is a sheet of polymer, such as polycarbonate, acrylic, or PVC. Other polymer materials can be used.

In the present methods, the solution 220 is a precursor for wet gel, such as a precursor for silica wet gel. Preferably, the solution (or “wet gel precursor”) includes water. Any of the advantageous precursors disclosed in the above-noted patent applications can be used. More generally, the present method is not limited to any particular precursor/solution.

Furthermore, the film 55 preferably is a polymer film that is flexible, e.g., configured to be wound about a reel. In FIGS. 1 and 2, the film 55 has opposed first and second end regions that are wound respectively about first and second reels 59. Accordingly, the present method can optionally include winding the film 55 about one or more (e.g., two) reels 59. In the non-limiting example of FIGS. 7A-7E, there can optionally be only one reel 59. As noted above, this can be a supply reel 59. In other embodiments, there can be two reels 59. This may involve, for example, a first of two reels 59 serving as a supply reel, while a second of the two reels 59 serves as a take-up reel.

The film 55 preferably has a thickness of less than 20 mils (i.e., less than 0.02 inch), such as about 10 mils (i.e., about 0.01 inch).

In some cases, the method subsequently includes moving the film 55 to convey the mold 100 from one position to another. It is to be appreciated, however, that this moving step is omitted in other embodiments of the present method (see e.g., FIGS. 7A-7E). With reference to the non-limiting examples of FIGS. 1 and 2, a method of moving the film 55 to convey the mold 100 from one position to another can optionally involve the film moving along one or more (e.g., first and second) rotating rollers 57 (and optionally additional rollers and/or other guides), which may be located between first and second reels 59.

Prior to filling the mold 100 with the solution 220, some embodiments of the method include assembling the mold spacer 70 and the mold lid 80 together with (e.g., onto) the casting substrate 50 to collectively form the mold. As noted above, the mold spacer 70 and the mold lid 80 preferably are separate bodies. The mold spacer 70 is configured to define sidewalls of the mold 100. When assembling the mold spacer 70 and the mold lid 80 onto the casting substrate 50, the casting substrate preferably is on top of a mold staging base 130. This is shown in the example of FIG. 1 (see the first illustrated station, which is furthest to the left in FIG. 1). Here, the mold staging base 130 preferably is stationary when assembling the mold spacer 70 and the mold lid 80 onto it. When provided, the mold staging base 130 can be a platen, table, or any other suitable base for supporting the mold components during their assembly. In certain embodiments, the mold spacer 70 and the mold lid 80 are assembled onto the casting substrate 50 to collectively form the mold 100 at a single position. The single position can optionally be within a mold press 600, e.g., according to the embodiment of FIGS. 7A-7E. In embodiments of this nature, the filling operation (i.e., delivering solution 220 into the mold 100) can optionally be performed at the same position.

Thus, in certain embodiments, the mold spacer 70 and the mold lid 80 are assembled onto the casting substrate 50 at a filling position. This can optionally be the case in the non-limiting examples of FIG. 2 and FIGS. 7A-7E.

As mentioned previously, the mold lid 80 can optionally include a port 90 that is accessed when filling the mold with the solution 220. This can be appreciated by referring to FIGS. 1 and 2 (see the second station in FIG. 1; see the first station in FIG. 2). In embodiments of this nature, the method preferably includes sealing the port 90 after filling the mold 100 with the solution 220. Various types of plugs 90′ can be used, such as a cork or rubber stopper. Another option is to use adhesive sealing tape. An alternative is to provide a filling port that opens through the mold spacer.

In certain embodiments, the filling clamp mechanism 200 includes a filling clamp port 206 configured to be in fluid communication with a port 90 in the mold lid 80 when filling the mold 100 (see FIG. 7B). In such embodiments, the solution 220 is delivered through the filling clamp port 206 and then through the port 90 in the mold lid 80 before reaching the cavity of the mold 100. Thus, the mold press 600 preferably is configured such that a filling clamp port 206 thereof is aligned with a port 90 in the mold lid 80 during a filling operation.

Preferably, the present method further includes allowing the solution 220 to undergo gelling and aging in the mold 100, thereby forming a wet gel sheet in the mold. During such gelling and aging, the casting substrate 50, the mold spacer 70, and the mold lid 80 preferably collectively seal, against evaporation, the solution 220 inside the mold 100.

In some method embodiments, the casting substrate 50 is on top of a mold staging base 130 when assembling the mold spacer 70 and the mold lid 80 onto the casting substrate, and the casting substrate is on top of a surface plate 160 when subsequently filling the mold with the solution 220. In embodiments of this nature, the method preferably includes moving the film 55 to convey the mold 100 (e.g., in a horizontal direction) from a staging position to a filling position. In such cases, the mold 100 when in the staging position is located directly above the mold staging base 130, whereas the mold when in the filling position is located directly above the surface plate 160. Reference is made to the non-limiting example of FIG. 1.

When filling the mold 100 with solution 220, the method may include clamping the mold lid 80, the mold spacer 70, and the casting substrate 50 by operating a filling clamp mechanism 200. Non-limiting examples of such methods are shown in FIGS. 1 and 2. Preferably, operating the filling clamp mechanism 200 applies downward force onto the mold lid 80. In some embodiments, this downward force is applied onto a perimeter area of the mold lid 80. It is to be appreciated that the perimeter area of the mold lid 80 is directly above the mold spacer 70. In the embodiments of FIGS. 7A-7E, the mold lid 80 may be applied to the mold spacer 70 by a press 202. In embodiments of this nature, the press may apply a downward force when applying the mold lid 80 to the mold spacer 70 to seal the mold cavity. In one or more embodiments, the downward force is provided by one or more cylinders (e.g., hydraulic or pneumatic) and/or pistons 204. The mold lid 80 may be loaded into the press 202, or positioned on the mold spacer 70 for sealing.

Referring again to FIGS. 1 and 2, it can be appreciated that the method can optionally include, after filling the mold 100 with the solution 220, (i) operating the filling clamp mechanism 200 to unclamp the mold lid 80, the mold spacer 70, and the casting substrate 50, and thereafter (ii) moving the film 55 to convey the mold 100 from the filling position (e.g., directly over a surface plate 160) to another position, such as a transfer position directly over a rigid substrate 180. Preferably, the filling position is directly over a surface plate 160, whereas the transfer position is directly over a rigid substrate 180, in such embodiments. As noted above, the surface plate 160 can optionally comprise (e.g., be) a granite surface plate, whereas the rigid substrate 180 can optionally comprise (e.g., be) a glass sheet. It is to be appreciated, however, that various other materials (e.g., other stone materials, glass, metal, polymer, wood, or composites) can alternatively be used for the surface plate 160.

With reference to FIGS. 7A-7D, it should be appreciated that the method can optionally include, after filling the mold 100 with the solution 220, (i) operating the filling clamp mechanism 200 to unclamp the mold lid 80, the mold spacer 70, and the casting substrate 50.

In some embodiments, the method further includes cutting the film 55 to create a trimmed film piece 55′. This can provide a subassembly comprising, in sequence: the rigid substrate 180, the trimmed piece of film 55′, the mold spacer 70, and the mold lid 80. This is perhaps best appreciated by referring to the cutting stations shown in FIGS. 1-2 and 7A-7E.

While FIGS. 1 and 2 depict embodiments wherein there is a cutting station downstream from a filling station, it is possible to combine these stations so that both filling and cutting are done at the same station. Reference is made to the non-limiting example of FIGS. 7A-7E, where both filling and cutting are done within a mold press 600. Here, a rigid substrate 180 is positioned on a substrate support 610 (e.g., a bottom platen) of the mold press 600 for assembling the mold according to one or more embodiments described herein. Another option is to provide a predetermined, desired length of film for use as the casting substrate, such that there is no subsequent cutting of the film. In such cases, the cutting station is omitted (see third station in FIG. 1; see the second station in FIG. 2).

In one or more embodiments, the invention provides an aerogel production method comprising operating a mold press 600 to accomplish one or more method steps described herein. With reference to FIGS. 7A-7E, the mold 100 preferably is positioned on a substrate support 610 (e.g., a bottom platen) within the mold press 600 such that the solution 220 is on top of the film 55, the film 55 is on top of a rigid substrate 180, and the rigid substrate 180 is on top of the support 610. The substrate support 610 (e.g., a bottom platen) preferably provides a level surface for supporting the bottom of the rigid substrate 180.

Thus, according to one or more embodiments, the substrate support 610 is located at a filling position within the mold press 600. The aerogel production method includes filling the mold 100 with solution 220, and the mold includes a mold base defined by a casting substrate 50, which comprises a film 55. When filling the mold 100 with the solution 220, the casting substrate 50 is preferably maintained in a stationary position within the mold press 600.

In one or more embodiments, the mold 100 includes a mold lid 80 extending over a mold cavity that receives the solution 220 when filling the mold with the solution. For example, the mold 100 preferably includes four sidewalls defined by a mold spacer 70, and the mold spacer is positioned removably on top of the casting substrate 50. The mold spacer 70 and the mold lid 80 preferably are separate bodies, and the mold spacer preferably is configured to define four sidewalls of the mold.

With continued reference to FIGS. 7A-7E, the aerogel production method preferably includes, prior to filling the mold 100 with the solution 220, positioning a mold spacer 70 and a mold lid 80 onto the casting substrate 50 to collectively form the mold 100. The mold spacer 70 is positioned on the casting substrate 50 and the mold lid 80 is applied to the mold spacer, optionally by operating a filling clamp mechanism 200 of the mold press 600. The filling clamp mechanism 200 may include a press 202 configured to carry a mold lid 80 such that operating the filling clamp mechanism 200 causes the press 202 to apply the mold lid 80 to the mold spacer 70 and press down on the mold lid, mold spacer, film, and rigid substrate. In one or more embodiments, operating the filling clamp mechanism 202 applies downward force at least onto a perimeter area of the mold lid 80, the perimeter area of the mold lid being directly above the mold spacer 70. Alternatively, the mold lid 80 can be assembled on the mold spacer 70, e.g., manually, and the filling clamp mechanism 200 can thereafter be operated to apply a downward force onto the mold lid 80 to clamp the mold lid to the mold spacer.

Thus, the aerogel production method preferably includes, when filling the mold 100 with the solution 220, clamping the mold lid 80, the mold spacer 70, and the casting substrate 50 by operating a filling clamp mechanism 200. In more detail, the mold lid, mold spacer, and casting substrate preferably are clamped in a sealed manner e.g., such that the solution does not leak out of the mold. The filling clamp mechanism 200 preferably remains in a clamped configuration with the mold 100 when filling the mold with solution. For example, in the embodiment of FIGS. 7A-7D, the mold press 202 contacts the mold lid 80 when filling the mold. Here, the filling clamp mechanism 200 further includes a filling clamp port 206 that is accessed when filling the mold 100 with the solution 220 (scc FIGS. 7B). In such embodiments, the filling clamp port 206 is in fluid communication with the port 90 in the mold lid 80 while filling the mold with the solution. Then, at some time after, the filling operation has been completed, the filling clamp mechanism 200 is further operated to unclamp the mold lid 80, the mold spacer 70, and the casting substrate 50. In some embodiments, the filling clamp mechanism 200 is actuated by a plurality of pistons 204, which may be hydraulic or pneumatic.

In one or more embodiments, the casting substrate 50 is on top of a rigid substrate 180 when positioning the mold spacer 70 and the mold lid 80 onto the casting substrate 50 and/or while filling the mold 100 with the solution 220. As previously described, the mold lid 80 preferably includes a port 90 that is accessed when filling the mold with the solution. The method preferably further includes sealing the port 90 after the mold has been filled with the solution.

In some cases, the aerogel production method further includes, prior to positioning the mold spacer 70 and the mold lid 80 onto the casting substrate 50, clamping the casting substrate such that it is stationary. Preferably, the film 55 when so clamped lies substantially flat across the rigid substrate 180. As noted above, the film 55 can optionally be clamped by at least one film brake. In the non-limiting examples of FIGS. 7A-7E, the mold press comprises a first film brake 62a located toward a front side of the mold press 600 and a second film brake 62b located toward a back side of the mold press 600.

Thus, in one or more embodiments, the method comprises clamping a leading end region of the film 55 with the second film brake 62b, located toward a back side of the mold press 600, such that the film 55 extends across the rigid substrate 180. Once the film 55 is clamped by the second film brake 62b, the reel 59 may be rotatably reversed to tension the film 55. This may be helpful for reducing wrinkles and/or to ensure that the film 55 is held in a smooth, flat configuration on the rigid substrate 180. Once the film 55 is tight, the method can optionally further comprise clamping the film 55 with the first film brake 62a, located toward a front side of the mold press 600, such that the film 55 is stationary and held taut.

When provided, the first and second film brakes 62a/62b may include a mechanism for grabbing or clamping the film to hold it stationary and taut. Preferably, the first and second film brakes 62a/62b hold the film 55 taut across the rigid substrate, avoiding winkles or bumps in the film 55. For example, each film brake may include a top portion and a bottom portion configured to move toward each other so as to clamp the casting substrate 50 therebetween. The top and bottom portions may receive the film 55 therebetween and clamp the film, thereby preventing movement of the film (see FIGS. 7C and 7E).

With continued reference to FIGS. 7A-7E, the illustrated mold press 600 includes first and second film brakes 62a/62b located on opposite sides of the substrate support 610 (e.g., bottom platen) and configured to clamp the film 55 on opposite sides of the rigid substrate 180. In some embodiments, the film 55 has leading and trailing end regions, the trailing end region is wound about a reel 59, and the leading end region is clamped by a second film brake 62b, such that a leading end of the film is a loose end extending beyond the second film brake 62b.

In one or more embodiments, the aerogel production method includes, prior to positioning the mold spacer 70 and the mold lid 80 onto the casting substrate 50, unspooling the film 55 from a reel 59, extending the film 55 across an upper surface of the rigid substrate 180, and clamping the leading end region of the film 55 with the second film brake 62b, e.g., such that the leading end of the film is a loose end extending beyond the first film brake 62b. In some embodiments, the method further includes clamping the trailing end region of the film 55 with a first film brake 62a. In embodiments of this nature, the second film brake 62b can optionally be in front of the rigid substrate 180 while the second film brake 62a is behind the rigid substrate. This can optionally be the case for any embodiment that involves two film brakes.

As noted above, the aerogel production method preferably includes cutting the film 55 to create a trimmed film piece 55′, thereby providing a subassembly comprising, in sequence: the rigid substrate 180, the trimmed film piece 55′, the mold spacer 70, and the mold lid 80. In some cases, this involves operating a first cutter 400a and a second cutter 400b. In some embodiments, as illustrated in FIGS. 7A-7E, the invention provides a mold press 600 comprising a first cutter 400a located toward a front side of the mold press 600 and a second cutter 400b located toward a back side of the mold press 600. In such embodiments, the first and second cutters 400a/400b are configured to cut the film 55 on opposite sides of the rigid substrate 180 and/or a substrate support 610 (e.g., a bottom platen). In one or more embodiments, the film 55 cutting is performed while the film is clamped, preferably using at least one film clamp, such as optional first and second film brakes 62a/62b.

In an embodiment according to FIGS. 7A-7E, the first cutter 400a is located between the rigid substrate 180 and the first film brake 62a. Additionally, the illustrated second cutter 400b is located between the rigid substrate 180 and the second film brake 62b. This configuration is not required. However, such embodiments may provide a particularly clean cut along the film due to the tension in the film as a result of being clamped at locations outside the first and second cutters.

In the embodiment illustrated in FIGS. 7A-7E, the first and second cutters 400a/400b preferably each include at least one blade configured to cut the film 55. When provided, the blade may be a rotatable blade configured to travel along a track 402 such that an entire width of the film 55 is cut by rolling the blade across the entire width of the film. Rather than using a rotatable blade, an angled razor blade may be moved along the film to cut it. Another option is using a laser cutter.

When provided, the first and second cutters 400a/400b preferably are configured to cut the film 55 and provide a loose end (or “overhanging edge”) of film that extends beyond the mold 100 at each of the front and back ends. In one or more embodiments, the first and/or second cutters are configured and operated to cut the film such that each loose end of film extends about 3 to 9 inches beyond the mold spacer 70 and/or the mold lid 80. Preferably, the first and/or second cutters are configured to cut the film such that each loose end of film extends about 6 inches beyond the mold spacer 70 and/or the mold lid 80.

Furthermore, the method can optionally include moving the subassembly into an aging clamp mechanism 300, and operating the aging clamp mechanism to deliver a clamping force to the subassembly. To move the subassembly to an aging clamp mechanism 300, one can manually move the subassembly to the aging clamp mechanism. Another possibility is to do this by automating a pick and transfer operation.

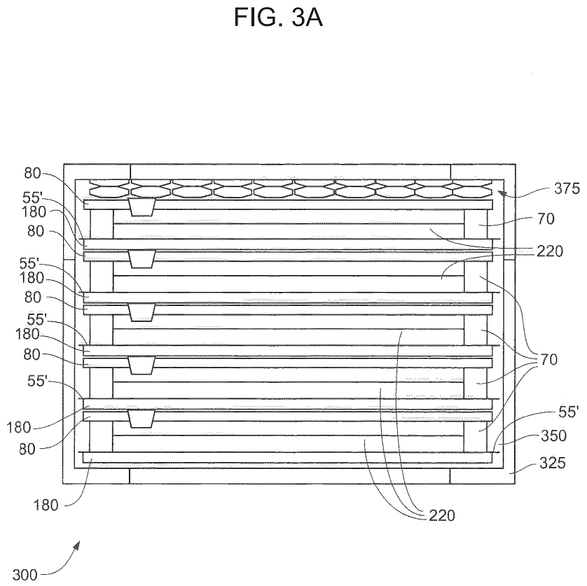

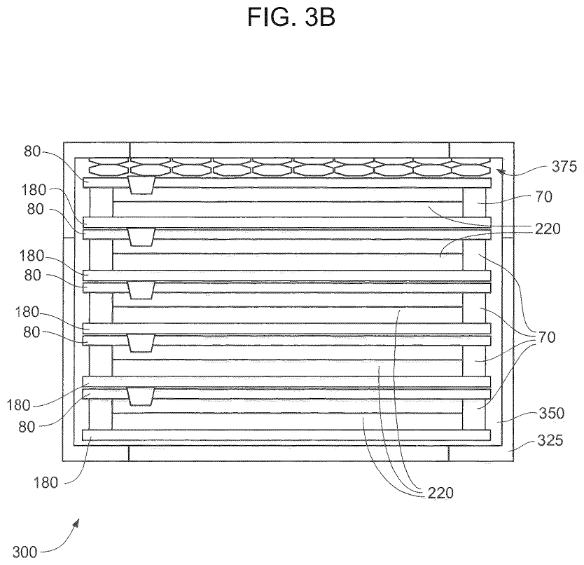

Operation of the aging clamp mechanism 300 preferably involves delivering clamping force to the subassembly while the subassembly is in a stack together with one or more other subassemblies that each include a rigid substrate 180, a trimmed piece of film 55′, a mold spacer 70, and a mold lid 80. This is shown in the non-limiting example of FIG. 3A. As to the present aging clamp 300 embodiment, it is also within the scope of this disclosure to simply use subassemblies having a rigid substrate 180, a mold spacer 70, and a mold lid 80 (without a trimmed film piece 55′). This is shown in the non-limiting example of FIG. 3B. In such embodiments, the wet gel may be casted to a rigid substrate 180. In one embodiment according to FIGS. 3A and 3B, the aging clamp mechanism 300 receives a stack of five subassemblies. It is to be appreciated, however, that the aging clamp mechanism 300 can be configured to receive a stack of more or fewer subassemblies. Moreover, the configuration of the aging clamp mechanism can be changed to accommodate the desired process and equipment.

The method preferably includes allowing the solution 220 to undergo gelling and aging in the mold 100, thereby forming a wet gel sheet in the mold. In embodiments involving an aging clamp mechanism 300, the subassembly preferably is retained in the aging clamp mechanism for an aging period of 192-288 hours. In some cases, the aging period is about 216-264 hours.

Thus, the method preferably includes allowing the solution 220 to undergo gelling and aging in the mold 100, thereby forming a wet gel sheet in the mold. Further, it is preferred to subsequently perform a solvent exchange on the resulting wet gel sheet, such that prior to the solvent exchange the wet gel sheet contains water and after the solvent exchange the wet gel sheet contains a liquid solvent selected from methanol, ethanol, 2-propanol, acetone, N,N-demethylformadide and demethylsulfoxide.

Still further, after the solvent exchange, the method preferably includes drying the wet gel sheet to convert it into an aerogel sheet. Drying the wet gel sheet may involve a drying operation selected from the group consisting of supercritical drying, freeze drying, and ambient drying. Preferably, the drying operation is supercritical drying.

Thus, the wet gel sheet may be placed in a freeze dryer, a supercritical dryer, or an ambient dryer. In such cases, the step of drying the wet gel sheet comprises either a freeze-drying process, a supercritical drying process, or an ambient drying process.

In some cases, the wet gel sheet is dried using a supercritical drying method (also known as a critical point drying method). As is well-known to skilled artisans, supercritical drying involves a solvent exchange. Specifically, the water initially inside the wet gel sheet is replaced with a suitable organic solvent (e.g., methanol, ethanol, or acetone). The wet gel sheet is then placed in a pressure vessel along with liquid carbon dioxide. The pressure vessel may be filled with, and emptied of, liquid carbon dioxide multiple times, so as to remove the organic solvent and leave liquid carbon dioxide in its place. The liquid carbon dioxide is then heated past its critical temperature and pressure and removed, thereby leaving an aerogel sheet.

In other cases, the wet gel sheet is dried using an ambient drying method. As used herein, ambient drying involves drying the wet gel sheet under ambient conditions (e.g., at a temperature in a range of from about 50 degrees to about 85 degrees Fahrenheit, and more typically in a range of from 68 degrees to 72 degrees Fahrenheit). The liquid in the wet gel sheet is allowed to slowly evaporate under controlled conditions, leaving an aerogel sheet. The controlled conditions ensure that the evaporation is slow enough that the gel network does not collapse during the drying. With ambient drying, the dryer is configured to establish a controlled environment in its interior. This may involve a controlled temperature, a controlled pressure, a controlled airflow, a controlled humidity, or any combination thereof.

In still other cases, the wet gel sheet is dried using a freeze-drying method. The wet gel sheet is frozen and then put into a vacuum chamber. The solvent is then removed to leave an aerogel sheet. Any suitable aerogel freeze-drying technique known in the art may be used. As non-limiting examples, the wet gel sheet can be placed into a household freezer, liquid nitrogen, or in a cryogenic mixture (e.g., a dry-ice/solvent mixture, such as a dry-ice and acetone bath).

In certain embodiments, the invention provides an aerogel production assembly comprising a film 55 and a film handling system 150. The film 55 is configured to serve as a casting substrate, and the film handling system 150 is configured to handle the film. Preferably, the film handling system is configured to provide (e.g., configured to retain at least a certain length of) the film at a filling station of the aerogel production assembly. The film handling system 150, for example, can optionally include at least one reel 59, such as a supply reel. In certain embodiments, the film handling system is part of a mold press 600. Reference is made to the non-limiting example of FIGS. 7A-7E. Here, the film handling system comprises a supply reel 59 and a guide roller 57.

In certain embodiments, the film handling system 150 is configured to convey the film 55 from one position (e.g., a filling position) to another position (e.g., a transfer position). Two non-limiting examples of such an aerogel production assembly are shown in FIGS. 1 and 2. In related method embodiments, the film 55 is used as a casting substrate for a wet gel precursor, and the film conveyor 150 is operated to move the film 55 (and a mold 100 comprising the film) from one position to another.

As noted above, in the present assembly embodiments, the film 55 is configured to serve as a casting substrate. Thus, a wet gel sheet can be molded/casted thereon. In more detail, a wet gel precursor can be received in a mold 100 that has a mold base defined by the film 55. Reference is made to the assembly and method embodiments described previously.

The solution 220 and the resulting wet gel preferably are entirely on top of the film 55, rather than being absorbed into it. This preferably is the case for any embodiment of this disclosure wherein solution 220 is provided on top of film 55.

The film 55 preferably has a thickness of less than 20 mils (i.e., less than 0.02 inch), perhaps about 10 mils (i.e., about 0.01 inch). The noted film thickness range can optionally be used in any embodiment involving the film 55.

The illustrated film 55 has free leading and trailing ends, rather than being a continuous loop. This too can optionally be the case in any embodiment involving the film 55. In addition, the film 55 preferably has a configuration that is entirely sheet-like (e.g., entirely planar), with no edges (e.g., no upstanding edges) that are integral (or permanently attached) to the illustrated film to define mold sidewalls. Here again, this can optionally be the case for any embodiment of the present disclosure that involves the film 55.

In some of the present assembly embodiments, and in some of the related method embodiments, the film handling system 150 is configured (and operated) to move the film from one position (e.g., a filling position) to another position (e.g., a transfer position). In certain embodiments, this involves the mold 100 moving from the one position (e.g., a filling position) to the other position (e.g., a transfer position). In other embodiments, the mold 100 may simply be moved manually (or by an automated pick and place operation).

Preferably, when the film 55 is operatively positioned (e.g., assembled operatively on the film handling system 150), it has a span extending over and along a top surface of a surface plate 160 (e.g., a casting table) and/or a rigid substrate 180. Reference is made to FIGS. 1 and 2 and also FIGS. 7A-7E. Furthermore, the film 55 when in the filling position preferably has a casting surface (i.e., a surface area that is directly beneath, and preferably contacts, the solution 220 when the mold 100 is filled) directly above a surface plate 160 or a rigid substrate 180. This is the case when using the mold press 600 of FIGS. 7A-7E. Also, this can be seen in the second station of FIG. 1 and the first station of FIG. 2. Here, the film 55 is in a filling position, as it has a top surface area that defines a bottom of the mold 100, and thus is a casting surface, which is directly above (and supported by) a surface plate 160. Similarly, in the embodiment of FIGS. 7A-7E, when the film 55 is in a filling position, it has a top surface area that defines a bottom of the mold, and thus is a casting surface, which is directly above (and supported by) a rigid substrate 180.

In certain embodiments, the span of the film 55, when operatively positioned, extends over and along an upper surface of an optional rigid substrate 180. According to certain embodiments as illustrated in FIGS. 1 and 2, the rigid substrate 180 preferably is located further along a downstream direction from where the surface plate 160 is located. Again, the systems of FIGS. 1 and 2 are non-limiting examples. In embodiments of this nature, the film 55 when in the transfer position has the noted casting surface directly above the optional rigid substrate 180. This can be seen at the third station of FIG. 1 and the second station of FIG. 2. Here, the film 55 is in a transfer position, with the noted casting surface (and a mold 100 for which the noted casting surface defines the mold base) directly above the rigid substrate 180. As noted above, however, the cutting station can alternatively be integrated into the filling station, e.g., such that there is no separate cutting station. One non-limiting example is shown in FIGS. 7A-7E. Moreover, the cutting station can be omitted entirely, e.g., in embodiments where the film 55 is initially provided in a predetermined, desired length (such that no subsequent cutting is involved).

As discussed previously, in embodiments that involve the rigid substrate 180, it can optionally be a glass sheet. Moreover, when provided, the surface plate 160 can optionally be a granite surface plate, in combination with the rigid substrate 180 being a glass sheet. It is to be appreciated, however, that various other materials are suitable alternatives for the surface plate 160 and/or the rigid substrate 180.

In some of the present embodiments, the film 55 when operatively positioned has a span extending through an optional cutting station. Thus, certain embodiments of the present aerogel production assembly include a cutting station configured to cut the film 55 (e.g., so as to create a trimmed film piece 55′). See the third station in FIG. 1, the second station in FIG. 2, and the integrated filling-cutting station of the mold press 600 shown in FIGS. 7A-7E. Here, the illustrated cutting station includes a first cutting device 400 at a front end of the cutting station and a second cutting device 400 at a back end of the cutting device. In FIGS. 7A-7E, the first cutting device is identified with reference number 400a, while the second cutting device is identified with reference number 400b. In other examples, there is only a single cutting device at a back end of the cutting station.

When provided, the cutting station includes at least one blade or other cutter configured to cut the film 55. In the non-limiting examples of FIGS. 1-2, and 7A-7E, the cutting station includes at least two cutting devices 400, each comprising one or more blades or other cutters configured to cut the film 55. Here, the illustrated cutting station includes a first cutting device 400 at a front end of the cutting station and a second cutting device 400 at a back end of the cutting station. While FIGS. 1, 2, and 7E schematically show the two cutting devices 400 as scissors, it is to be appreciated that these cutting devices can each simply comprise a single blade (e.g., a razor blade), which can optionally be moveable along an entire width of the film 55 so as to cut the film, when so desired, along its entire width. The single blade can advantageously be a cutting wheel. Another option is to use a laser cutter.

In other embodiments, the cutting station is integrated into the filling station. Reference is made to the non-limiting example of FIGS. 7A-7E. In such embodiments, there can be a first cutting device at a front end of the filling-cutting station and a second cutting device at a back end of the filling-cutting station. In other examples, there is only a single cutting device at a back end of the filling-cutting station. In the embodiments illustrated in FIGS. 7A-7E, each cutting device 400a, 400b preferably comprises a blade configured to move along an entire width of the film 55 so as to cut the film along its entire width.

In some cases, the film 55 is configured to extend continuously from a filling position, where a wet gel precursor solution 220 is delivered downwardly into a mold 100 having a mold base defined by the film, to a cutting station downstream of the filling position. Reference is made once again to the non-limiting examples of FIGS. 1 and 2. When provided, the cutting station preferably includes at least one blade (e.g., defined by a cutting mechanism 400) configured to cut the film 55. In other cases, a laser is used for cutting the film.

With respect to the film handling system 150, it can optionally include at least one reel, such as first and second reels 59. In such cases, the film 55 preferably has opposed first and second end regions wound respectively about the first and second reels 59. The first reel 59 can optionally serve as a supply reel, while the second reel 59 serves as a take-up reel. In other embodiments, the film handling system only has one reel for handling the film, e.g., the supply reel 59 in FIGS. 7A-7E. Additionally or alternatively, the film handling system 150 can optionally include first and second rotatable rollers 57. When provided, the first and second rotatable rollers 57 preferably are configured to contact the film 55 while rotating. In FIGS. 1 and 2, the illustrated film 55 is in contact with, and is guided along, first and second rotatable rollers 57 that are located between first and second reels 59. If desired, there may be additional guide rollers or other roller arrangements, depending upon the details of the desired system. In other embodiments, there may be only a single roller 57 guiding the film 55. Reference is made once again to the non-limiting example shown in FIGS. 7A-7E. Instead of the rollers 57, it may be desirable to simply provide one or more stationary rods, bars, or other guides along which the film 55 can simply slide.

In some of the present embodiments, the aerogel production assembly further includes a filling clamp mechanism 200. When provided, the filling clamp mechanism 200 is configured to clamp a mold 100 that has a mold base defined by the film 55. Exemplary embodiments of a filling clamp mechanism 200 have already been described. It preferably is configured to clamp the mold by applying downward force onto (e.g., at least onto a perimeter area of) the mold 100. In some embodiments, the filling clamp mechanism 200 is configured to clamp the mold 100 while leaving a top area (e.g., a majority of the top surface area) of the mold exposed so as to be accessible for filling the mold with solution 220. This is shown in the non-limiting examples of FIGS. 1 and 2. In other embodiments, the filling clamp mechanism 200 comprises a filling clamp port 206, and the filling clamp port 206 is configured to be in fluid communication with a port 90 in the mold lid 80, such that the solution 220 may be delivered through the filling clamp port 206 of the filling clamp mechanism 200. In one or more embodiments, the filling clamp mechanism 200 comprises a press 202 having the filling clamp port 206 extending therethrough.

In embodiments that include the optional filling clamp mechanism 200, the film handling system 150 preferably is configured to handle the film 55 such that at least a certain extent (e.g., a desired length) of the film is located beneath the filling clamp mechanism. In more detail, the film handling system 150 can supply the film 55 such that it extends to (e.g., beneath) the filling clamp mechanism 200, which preferably is configured to apply pressure onto a mold 100 that includes the film 55 as a casting substrate. Thus, in some embodiments of the aerogel production assembly, it includes a filling clamp mechanism 200 operably coupled with a film handling system 150. Three non-limiting examples are shown in FIGS. 1, 2, and 7A-7D. In the embodiment of FIGS. 7A-7D, the mold press includes a filling clamp mechanism operably coupled with a film handling system at a filling station. In the embodiment illustrated, the filling station is an integrated filling-cutting station. Alternatively, there can be a separate, subsequent (or preceding) cutting station.

In the present embodiments, the aerogel production assembly can optionally further include an aging clamp mechanism 300. When provided, the aging clamp mechanism 300 preferably has a chamber 350 (e.g., surrounded by a housing 325) configured to receive a batch of molds each containing a solution 220 that undergoes gelling and aging while the batch of molds is in the chamber of the aging clamp mechanism. Preferably, the chamber 350 of the aging clamp mechanism 300 is configured to receive the batch of molds in a stacked arrangement wherein the molds are stacked one on top of another. Reference is made to the non-limiting embodiments of FIGS. 3A and 3B. Here, the illustrated aging clamp mechanism 300 includes a clamp 375 configured to deliver clamping force to the molds of the batch when they are received in the chamber 350 in the stacked arrangement. More will be said of the optional aging clamp mechanism 300 later.

In any embodiment of the present disclosure, the wet gel sheet can optionally have a thickness in a range of from 1.5 mm to 15 mm, such as from 2 mm to 8 mm, or from 2 mm to 4 mm (e.g., 3 mm) or perhaps from 3 mm to 5 mm. Moreover, the solution 220 can optionally be filled into the mold 100 at a depth within any one or more of these ranges. Similarly, the resulting aerogel sheet can optionally have a thickness within any one or more of these thicknesses. It is to be appreciated, however, that other thicknesses can be used. Preferably, the wet gel sheet is devoid of flexible fibrous material and/or is devoid of fibers. For example, it preferably is not a fabric or blanket embedded in aerogel. Moreover, when provided, the solution 220 and the resulting wet gel preferably are entirely on top of the film 55, rather than being absorbed into it. This can optionally be the case for any embodiment of the present disclosure. In some embodiments, the wet gel sheet consists essentially of (or consists of) a silica skeleton and one or more solvents.

In some embodiments, the aerogel production assembly further includes a solvent exchange station, a drying station, or both. When provided, the solvent exchange station can be configured to perform solvent exchange on the wet gel sheet using any conventional wet gel solvent exchange method and solvent material. Generally, the wet gel sheet will be subjected to a solvent for a desired period of time so that water in the pores is replaced with the solvent. In many cases, the wet gel sheet is placed in a solvent bath to perform the solvent exchange.

Preferably, the aerogel production assembly further includes a drying station. In such cases, any conventional aerogel drying method can be used. Thus, the wet gel sheet can be placed in a freeze dryer, a supercritical dryer, or an ambient dryer. In such cases, the method of drying the wet gel sheet comprises a freeze-drying process, a supercritical drying process, or an ambient drying process.

In some cases, the drying station comprises a supercritical drying chamber. In such cases, the wet gel sheet is dried using a supercritical drying method (also known as a critical point drying method). Supercritical drying commonly follows a solvent exchange, as noted above. For example, water initially inside the wet gel sheet can be replaced with a suitable organic solvent (e.g., methanol, ethanol, or acetone). The wet gel sheet can then be placed in a pressure vessel along with liquid carbon dioxide. The pressure vessel can be filled with, and emptied of, liquid carbon dioxide multiple times, so as to remove the organic solvent and leave liquid carbon dioxide in its place. The liquid carbon dioxide can then be heated past its critical temperature and pressure and removed, thereby leaving an aerogel sheet.

In other cases, the wet gel sheet is dried using an ambient drying method. Ambient drying involves drying the wet gel sheet under ambient conditions (e.g., at a temperature in a range of from about 50 degrees to about 85 degrees Fahrenheit, and more typically in a range of from 68 degrees to 72 degrees Fahrenheit). The liquid in the wet gel sheet is allowed to slowly evaporate under controlled conditions, leaving an aerogel sheet. The controlled conditions ensure that the evaporation is slow enough that the gel network does not collapse during the drying. With ambient drying, the dryer is configured to establish a controlled environment in its interior. This may involve controlled temperature, controlled pressure, controlled airflow, controlled humidity, or any combination thereof.

In still other cases, the wet gel sheet is dried using a freeze-drying method. In such cases, the wet gel sheet is frozen and then put into a vacuum chamber. The solvent is then removed to leave an aerogel sheet. Any suitable aerogel freeze-drying technique known in the art may be used. As nonlimiting examples, the wet gel sheet can be placed into a household freezer, liquid nitrogen, or in a cryogenic mixture (e.g., a dry-ice/solvent mixture, such as a dry-ice and acetone bath).

The resulting aerogel sheet preferably is self-supporting, i.e., once fully synthesized and formed, the sheet can retain sheet form without being adhered to glass or another support. The aerogel sheet can be a transparent, brittle aerogel sheet. Furthermore, the aerogel sheet can be sufficiently rigid that it cannot be wound. If desired, the aerogel sheet can consist essentially of (or consist of) aerogel. In such cases, the resulting aerogel sheet is devoid of any internal film, fabric, honeycomb, or other support. This can optionally be the case for any embodiment of the present disclosure. In many cases, the aerogel sheet is a silica aerogel sheet.

The resulting aerogel sheet can have a major dimension (e.g., a length or width) of at least 0.375 meter, for example at least about 0.7 meter, 0.75 meter, 0.8 meter, 0.85 meter, 0.9 meter, 0.95 meter, 1.0 meter, or in some cases at least about 1.125 meters or 1.25 meters. In certain embodiments, the aerogel sheet has a major dimension of between 0.7 meter and 3 meters. In specific embodiments, the aerogel sheet has a major dimension of at least 0.9 meter. In addition, the wet gel sheet can optionally have dimensions in any one or more of the foregoing ranges. The foregoing dimension ranges can optionally be used in any embodiment of this disclosure.

Certain embodiments of the invention provide an aerogel production assembly comprising an aging clamp mechanism 300. The aging clamp mechanism 300 is configured to deliver clamping force to a batch of molds. Some of the present embodiments provide the aging clamp mechanism 300 on its own, whereas others provide it as one component of an aerogel production assembly that includes other components, such as those described elsewhere in the present disclosure. Certain embodiments provide methods of operating the aging clamp mechanism, either on its own or as part of an aerogel production method involving other method steps disclosed herein.

The aging clamp mechanism 300 has a chamber 350 configured to receive the molds of the batch in a stacked arrangement wherein the molds are stacked one on top of another. Preferably, the aging clamp mechanism 300 includes a clamp 375 at an upper region of the chamber 350. Alternatively, the clamp can be provided at a lower region of the chamber. Either way, the clamp 375 is configured to deliver the clamping force to the batch of molds. In more detail, the illustrated clamp 375 is adjacent a ceiling of the chamber 350, so as to be positioned to bear against an uppermost one of the molds in the stacked arrangement. When the aging clamp mechanism 300 is in a loaded, clamped position, the molds of the batch are received in the chamber 350 in the stacked arrangement with the clamp 375 bearing against the uppermost one of the molds in the stacked arrangement. In some cases, the stacked arrangement is characterized by the molds being stacked directly one on top of another. Each of the illustrated molds includes, in sequence from bottom to top, a rigid substrate 180, a mold spacer 70, and a mold lid 80. In some cases, the mold spacer 70 and the mold lid 80 are separate bodies, and the mold spacer defines sidewalls of the mold. In embodiments where the wet gel is casted to a film, each mold includes, in sequence from bottom to top, a rigid substrate 180, a piece of film 55′, a mold spacer 70, and a mold lid 80. In the present embodiments, each of the molds preferably contains a wet gel sheet, at least once gelling and aging of the solution 220 are done.

The housing 325 may be configured to establish and maintain a controlled environment in the chamber 350. For example, the housing 325 may be configured to be closed and sealed such that the housing 325 isolates a plurality of molds therein in an airtight manner, e.g., to prevent ambient air from entering the housing once it has been closed and sealed. This may provide additional protection against evaporation of the solution inside the mold during the gelling and aging.

In some cases, the aging clamp mechanism 300 is part of an aerogel production assembly that includes other components, such as a prior wet gel casting and handling system, a subsequent solvent exchange station, and a final drying station. Various options have already been described for a prior wet gel casting system, a subsequent solvent exchange station, and a final drying station. As noted above, the drying station preferably comprises (e.g., is) a supercritical drying chamber.

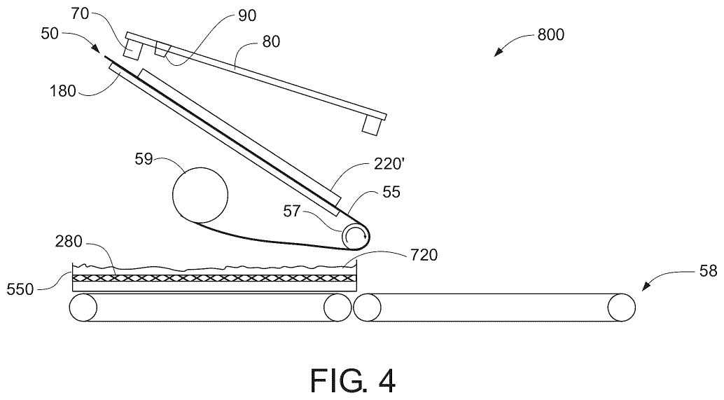

In some embodiments, the invention provides an aerogel production method involving a wet gel sheet 220′ casted to a casting substrate 50. In the present method, the casting substrate 50 comprises (e.g., is) a film 55 (or trimmed film piece 55′), and the method includes peeling (or “delaminating”) the film off the wet gel sheet 220′. Reference is made to the embodiments of FIGS. 4-6 and 8A-8B.

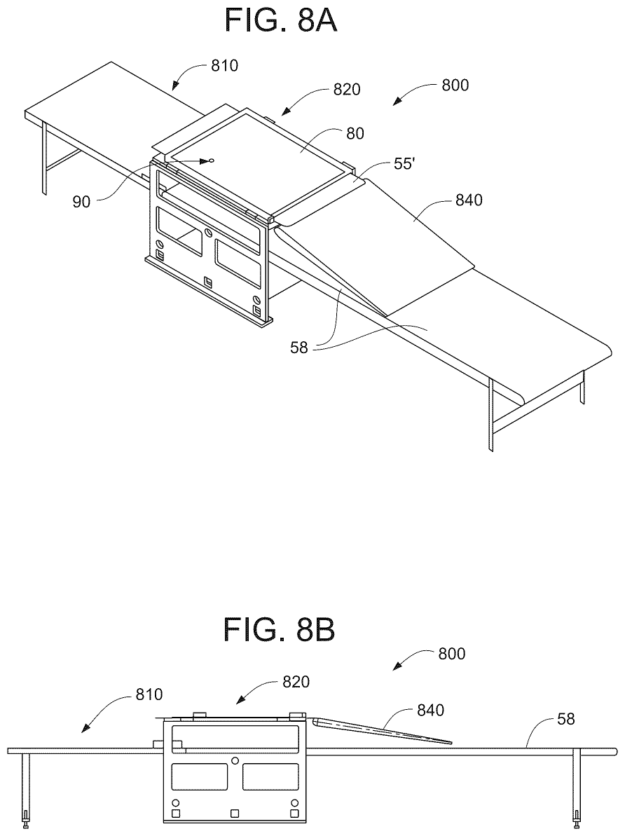

In one or more embodiments, an aerogel production method comprises a wet gel removal device 800. The wet gel removal device 800 is configured to peel or delaminate the film 55 (or trimmed film piece 55′) off the wet gel sheet 220′ (see FIGS. 4-6 and 8A-8B) in accordance with one or more embodiments described herein. In the embodiment of FIGS. 8A-8B, the mold removal device 800 includes a pan loading area 810, a mold loading area 820, a film conveyor 840, and a pan conveyor 58.

Preferably, the method includes both peeling the film off the wet gel sheet 220′ and conveying or otherwise delivering the wet gel sheet onto a drying substrate 280. In one or more embodiments, the conveying or otherwise delivering the wet gel sheet onto a drying substrate 280 is done via a film conveyor 840. In some cases, the drying substrate 280 comprises (e.g., is) a stainless steel mesh sheet. If desired, mesh sheets of other material can be used instead. The drying substrate 280 (whether it comprises mesh or something else) can optionally have openings through which liquid solvent can pass.

In certain embodiments, when the wet gel sheet 220′ is conveyed or otherwise delivered onto the drying substrate 280, the drying substrate is in a pan 550. When provided, the pan 550 preferably has a closed bottom, closed side(s), and an open top. The pan can be provided in the form of various tray, bin, or pool configurations. If desired, a drying substrate or another wet gel support can be conveyed alone (i.e., without being received in any pan) by the pan conveyor 58.

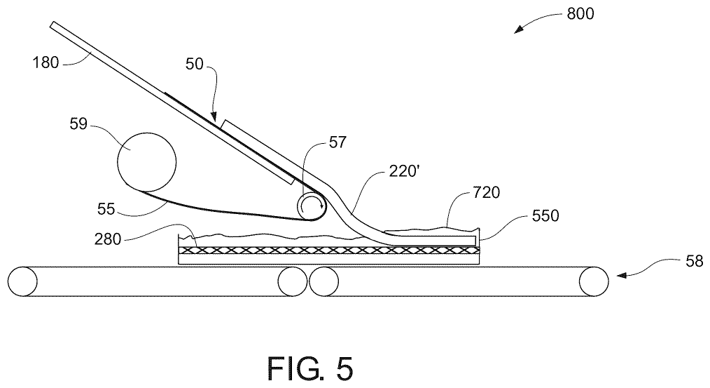

In some embodiments that involve a pan 550, it contains a liquid solvent 720. In such cases, the pan 550 preferably is filled with enough liquid solvent 720 that the drying substrate 280 is entirely submerged in the liquid solvent. This is shown in the non-limiting example of FIG. 5. In such cases, when the wet gel sheet 220′ is conveyed or otherwise delivered onto the drying substrate 280, the wet gel sheet preferably contacts the liquid solvent 720 in the pan 550 before contacting the drying substrate. This can optionally be done with the goal of reducing the stress the wet gel sheet 220′ experiences when conveyed or otherwise delivered onto the drying substrate 280.

In other embodiments that involve a pan 550, it does not contain a liquid solvent 720 when the wet gel sheet 220′ is conveyed or otherwise delivered onto the drying substrate 280. This may be efficient, for example, in cases where the system is configured to deliver the wet gel sheet onto the drying substrate without putting much stress on the wet gel sheet.

In the non-limiting example of FIGS. 4-6, the drying substrate 280 is illustrated as a separate body from the pan 550. In other examples, the drying substrate can simply be defined by the bottom wall of the pan. Preferably, though, the drying substrate 280 is a separate body from the pan 550, and it can optionally have a plurality of openings through which liquid solvent 720 can pass, and it can optionally be disposed in the pan in a position elevated above a bottom inside surface of the pan.

In FIGS. 4-6, the illustrated liquid solvent 720 can optionally be selected from methanol, ethanol, 2-propanol, acetone, N,N-demethylformadide and demethylsulfoxide. Thus, some non-limiting examples use methanol as the liquid solvent 720.

During a period of time, the method may involve simultaneously performing: (i) peeling the film 55 (or trimmed film piece 55′) off the wet gel sheet 220′, and (ii) conveying or otherwise delivering the wet gel sheet onto the drying substrate 280. Moreover, while peeling the film 55 (or trimmed film piece 55′) off the wet gel sheet 220′, the method can advantageously include conveying the drying substrate 280 (e.g., horizontally) in a machine direction. In some embodiments, conveying the drying substrate 280 in a machine direction can be done by a pan conveyor 58. During such conveyance of the drying substrate 280, it can optionally be located at a lower elevation than (e.g., directly beneath) an overlying path of travel for the wet gel sheet. Reference is made to FIGS. 4 and 8A-8B.

When the illustrated drying substrate 280 is being conveyed in a machine direction (e.g., see FIG. 4 and FIGS. 8A-8B), the horizontal velocity component of the wet gel sheet 220′ may be the same (or at least substantially the same) as the velocity of the drying substrate. This can optionally be the case, for example, when the wet gel sheet 220′ initially comes into contact with the drying substrate 280 and during the ensuing period of time when its length is being laid thereon. It is to be appreciated, however, that this is not required. As just one example, the drying substrate may alternatively be in a stationary position when the wet gel sheet is conveyed or otherwise delivered onto it. In cases where the drying substrate 280 is in a stationary position while the wet gel sheet 220′ is delivered onto it, a film conveyor 840 can optionally be configured to move backwardly as the wet gel sheet is gently laid down onto the stationary drying substrate.

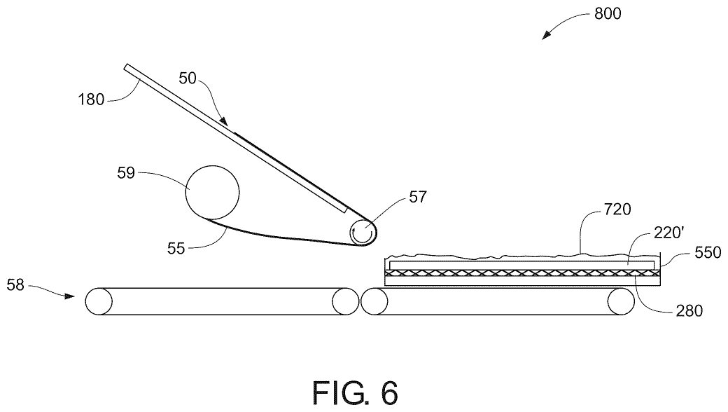

As shown in the non-limiting example of FIG. 6, the method can optionally include simultaneously: (i) peeling the film 55 off the wet gel sheet 220′, (ii) conveying the wet gel sheet onto the drying substrate 280, and (iii) conveying the drying substrate in a machine direction (i.e., left to right, as seen in FIGS. 4-6 and 8A-8B).

In some cases, the conveyance of the wet gel sheet 220′ onto the drying substrate 280 involves the wet gel sheet moving along a downwardly sloped path, such as a film conveyor 840 as illustrated in FIGS. 8A-8B. In such cases, the downwardly sloped path may extend at an angle inclined downwardly from a horizontal axis, for example, by 60 degrees or less, such as from 5 to 45 degrees, or from 5 to 35 degrees.

In the embodiments of FIGS. 4-6 and 8A-8B, the wet gel sheet 220′ is conveyed along a downwardly sloped path before its leading end comes into contact with the drying substrate 280. In the example illustrated, the pan 550 (and thus the drying substrate 280) is moving (e.g., horizontally) while the wet gel sheet 220′ is conveyed along a downwardly sloped path and thereby lowered onto the drying substrate 280. In some cases, both the illustrated pan 550 and the wet gel sheet 220′ are moving (optionally with the same, or substantially the same, horizontal component velocity) while the wet gel sheet 220′ is being lowered onto the drying substrate 280. In other cases, the pan is stationary while the components handling the wet gel sheet are moved (e.g., from right to left) relative to the pan so as to lay the wet gel sheet down onto the drying substrate.

In certain preferred embodiments, while peeling the film 55 (or trimmed film piece 55′) off the wet gel sheet 220′, the film moves in a diverging manner relative to a direction in which the wet gel sheet is travelling. This is perhaps best appreciated by referring to FIGS. 5 and 6. In some embodiments of this nature, the film 55 is peeled off the wet gel sheet 220′ while the film moves along a rotating roller 57. In the example illustrated in FIGS. 4-6, while the film 55 is peeled off the wet gel sheet 220′, the film is in contact with the rotating roller 57, whereas the wet gel sheet is supported by, but does not contact, the rotating roller. In other examples, the roller 57 shown in FIGS. 4-6 is omitted and the film instead wraps around a rod, frame member, a leading end of a plate, or the like. In such cases, the film may simply slide over the rod, frame member, plate, or other body.

In certain alternative embodiments, the illustrated roller 57 is omitted, and the film is wrapped downwardly around the leading end of the rigid substrate 180 and pulled rearwardly beneath the rigid substrate. In such alternative embodiments, the film can be pulled rearwardly with a roller, e.g., generally like the one shown in FIGS. 4-6. Another possibility is to pull the film back manually or through other automation equipment.

Furthermore, when peeling the film 55 off the wet gel sheet 220′, the film preferably moves along the rotating roller 57 in a diverging manner relative to a direction in which the wet gel sheet is travelling. If desired, the rotating roller 57 can be replaced with a non-rotating bar or other guide along which the film simply slides. As shown in FIGS. 4-6, the step of peeling the film 55 off the wet gel sheet 220′ can optionally include moving the film by winding it onto a reel 59.

Prior to peeling the film 55 off the wet gel sheet 220′, the wet gel sheet and the film preferably are part of a subassembly comprising, in sequence: a rigid substrate 180, the film 55 (or trimmed film piece 55′), a mold spacer 70, and a mold lid 80. In such cases, the method preferably includes separating the mold spacer 70 and the mold lid 80 (which may be separate bodies, as illustrated, or may alternatively be integral portions of a single body) from the film 55 (or trimmed film piece 55′), the wet gel sheet 220′, and the rigid substrate 180 prior to peeling the film off the wet gel sheet. This can be done manually or through automation. Reference is made to FIG. 4. The separation of the mold spacer 70 and the mold lid 80 from the film 55 (or trimmed film piece 55′), wet gel sheet 220′, and rigid substrate 180 may include lifting the mold spacer and mold lid away from the film, wet gel sheet, and rigid substrate. Preferably, the method further includes sliding the film 55 and the wet gel sheet 220′ together off the rigid substrate 180. This is shown in FIGS. 4-6. In one or more embodiments, lifting the mold spacer and mold lid away from the film, wet gel sheet, and rigid substrate is done at a mold loading area 820, as seen in FIGS. 8A-8B.

Thus, in the embodiments of FIGS. 4-6 and 8A-8B, the wet gel sheet 220′ ends up resting on the drying substrate 280. In some cases, the wet gel sheet 220′ ends up being in (e.g., submerged in) liquid solvent 720 in an optional pan 550.

With particular reference to FIGS. 8A-8B, a wet gel removal device 800 is illustrated according to one or more embodiments disclosed herein. The wet gel removal device 800 is configured to peel or delaminate the trimmed film piece 55′ off the wet gel sheet 220′ in accordance with one or more embodiments described herein. The illustrated wet gel removal device 800 includes a pan loading area 810 connected to a pan conveyor 58. The pan conveyor 58 is configured to convey a pan 550 and/or a drying substrate 280 in a machine direction to receive the wet gel sheet 220′, according to one or more embodiments herein. The illustrated wet gel removal device 800 further includes a mold loading area 820 connected to a film conveyor 840. The film conveyor 840 is configured to peel the trimmed film piece 55′ off the wet gel sheet 220′ and convey the wet gel sheet onto the drying substrate 280.

With continued reference to FIGS. 8A-8B, after the wet gel sheet 220′ has aged and is ready for removal, the method comprises placing the mold subassembly onto the mold loading area 820 so that the trimmed film piece 55′ overlaps with the film conveyor 840. The mold subassembly preferably comprises, in sequence: a rigid substrate 180, the trimmed film piece 55′, a mold spacer 70, and a mold lid 80. In one or more embodiments, the method comprises securing the trimmed film piece 55′ to the film conveyor 840 while it is stationary. For example, the film can optionally be secured to the film conveyor 840 using an adhesive, such as tape. Another option is to provide one or more clamps or other fasteners on the conveyor for clamping or otherwise fastening a leading edge region of the trimmed film piece on/to the conveyor.

In one or more embodiments, the conveyance of the wet gel sheet 220′ onto the drying substrate 280 involves the wet gel sheet moving along a film conveyor 840. In such cases, the film conveyor 840, can optionally define a downwardly sloped path and may extend at an angle inclined downwardly from a horizontal axis, for example, by 60 degrees or less, such as from 5 to 45 degrees, or from 5 to 35 degrees. In a preferred embodiment, the film conveyor 840 comprises a conveyor belt.

When placing the mold subassembly onto the mold loading area 820, there can optionally be a pan 550 in the pan loading area 810. In one or more embodiments, the pan loading area 810 is located behind the mold loading area 820. Additionally, the pan loading area 810 can optionally be located on a level below the mold loading area 820.

Prior to peeling the piece of film 55′ off the wet gel sheet 220′, the wet gel sheet and the film preferably are part of a subassembly comprising, in sequence: a rigid substrate 180, the piece of film 55′, a mold spacer 70, and a mold lid 80. In such cases, the method preferably includes separating the mold spacer 70 and the mold lid 80 (which may be separate bodies, as illustrated, or may alternatively be integral portions of a single body) from the trimmed film 55′, the wet gel sheet 220′, and the rigid substrate 180 prior to peeling the film off the wet gel sheet. This can be done manually or through automation. The separation of the mold spacer 70 and the mold lid 80 from the trimmed film piece 55′, wet gel sheet 220′, and rigid substrate 180 may include lifting the mold spacer and mold lid away from the film, wet gel sheet, and rigid substrate.

Once both the mold subassembly and the pan 550 are positioned, the method further comprises operating (e.g., activating) the film conveyor 840 and the pan conveyor 58. In one or more embodiments, the film conveyor 840 and the pan conveyor 58 operate at speeds such that the relative motion of the wet gel and the pan 550 are in sync.

Preferably, the method includes sliding the trimmed film piece 55′ and the wet gel sheet 220′ together off the rigid substrate 180. In one or more embodiments, when operating the film conveyor 840, the method comprises dragging the trimmed film piece 55′ (together with the wet gel sheet) off the rigid substrate 180. The illustrated film conveyor 840 is configured to drag the film off the rigid substrate and convey the film (together with the wet gel sheet thereon) along a downwardly sloped path toward the pan 550 (and/or the drying substrate 280), which is travelling along the pan conveyor 58. In embodiments of this nature, the rigid substrate 180 may optionally be secured to the mold loading area 820 so the rigid substrate does not slide onto the film conveyor 840 together with the trimmed film 55′ and the wet gel sheet 220′. The mold loading area 820 may further comprise a ledge or other stop mechanism configured to prevent the rigid substrate 180 from sliding onto the film conveyor 840. When provided, the method may include sliding the trimmed film piece 55′ and the wet gel sheet 220′ together over a ledge and off the rigid substrate 180, such that the ledge stops the rigid substrate from sliding onto the film conveyor 840. The illustrated film conveyor 840 is configured to drag the film off the rigid substrate and convey the film (together with the wet gel sheet thereon) along a downwardly sloped path toward the pan 550 (and/or the drying substrate 280), which is travelling along the pan conveyor 58.

When the piece of film 55′ reaches the end of the film conveyor 840, it is pulled around the edge of the conveyor belt, thereby peeling it away from the wet gel sheet 220′ and returning along an underside of the conveyor belt. As the wet gel sheet 220′ delaminates from the film, it is delivered downwardly onto the drying substrate 180, which preferably is received in a pan 550. The pans loaded with wet gel sheets 220′ may then be moved on to solvent exchange and eventual supercritical drying.

Thus, the method may further include subsequently performing a solvent exchange on the wet gel sheet 220′. In such cases, prior to the solvent exchange the wet gel sheet 220′ contains water, and after the solvent exchange the wet gel sheet preferably contains a liquid solvent selected from methanol, ethanol, 2-propanol, acetone, N,N-demethylformadide and demethylsulfoxide.

Furthermore, after the solvent exchange, the method preferably includes drying the wet gel sheet 220′to convert it into an aerogel sheet. As noted above, various drying techniques can be used. In some cases, the wet gel sheet is dried by supercritical drying.

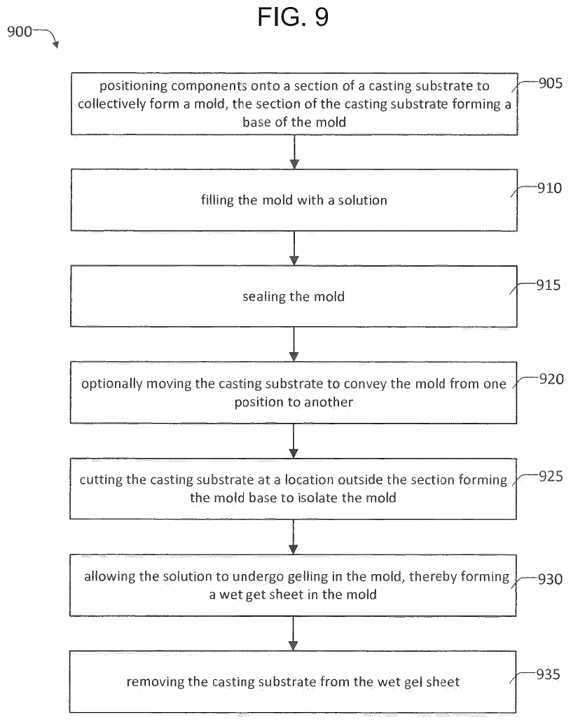

FIGS. 1-8B illustrate non-limiting examples of equipment and components that can be used to perform various aerogel production methods outlined in FIGS. 9-12 and according to certain embodiments described herein.

With reference to FIG. 9, an aerogel production method 900 is outlined. At step 905, the method includes positioning components onto a section of a casting substrate to collectively form a mold, such that the section of the casting substrate forms a base of the mold. In some embodiments, this includes positioning a mold spacer 70 and a mold lid 80 onto the casting substrate 50 to collectively form the mold 100. Preferably, step 905 occurs prior to filling the mold with the solution 220 (step 910). The mold spacer and mold lid may be separate bodies and the mold spacer may be configured to define four sidewalls of the mold. The casting substrate 50 may be on top of a mold staging base 130 or a rigid substrate 180 when positioning the mold spacer and the mold lid onto the casting substrate.

At step 910, the method further includes filling the mold with a solution. In certain embodiments, the mold 100 includes a mold base defined by a casting substrate 50, and the casting substrate comprises a film 55. When filling the mold 100 with the solution 220, the casting substrate 50 may be maintained in a stationary position on top of a stationary surface plate 160 and/or rigid substrate 180. The mold 100 may include a mold lid 80 extending over a mold cavity that receives the solution 220. The mold may further include four sidewalls defined by a mold spacer 70, and the mold spacer may be positioned removably on top of the casting substrate 50. In one or more embodiments, the mold lid 80 includes a port 90 that is accessed when filling the mold with the solution 220.

In one or more embodiments, step 910 may include, when filling the mold 100 with the solution 220, clamping the mold lid 80, the mold spacer 70, and the casting substrate 50 by operating a filling clamp mechanism 200. In such embodiments, the filling clamp mechanism 200 may be operated to apply downward force onto at least a perimeter area of the mold lid 80. It will be appreciated that the method may subsequently include, after clamping the mold lid 80, the mold spacer 70, and the casting substrate 50, operating the filling clamp mechanism 200 to unclamp the mold lid 80, the mold spacer 70, and the casting substrate 50.

At step 915, the method further includes sealing the mold 100. Preferably, the port 90 is sealed after filling the mold 100 with the solution 220.

At step 920, the method may optionally include moving the casting substrate to convey the mold from one position to another. In one or more embodiments described herein, the film 55 has opposed first and second end regions that are wound respectively about first and second reels 59. In such embodiments, moving the film 55 may involve the film moving along first and second rotating rollers 57 that are located between the first and second reels 59. For example, in such embodiments, the casting substrate 50 may be on top of a stationary mold staging base 130 when positioning the mold spacer 70 and the mold lid 80 onto the casting substrate 50, whereas the casting substrate is on top of a stationary surface plate 160 when filling the mold 100 with the solution 220, and the method includes moving the film 55 to convey the mold 100 from the staging position to the filling position. In some embodiments of this nature, the mold 100 when in the staging position is located directly above a stationary mold staging base 130, whereas the mold when in the filling position is located directly above a stationary surface plate 160. In such cases, the method may further include moving the film 55 to convey the mold 100 from the filling position to a transfer position, e.g., such that the mold when in the transfer position is directly above a rigid substrate 180.

At step 925, the method further includes cutting the casting substrate 50 at a location outside the section forming the mold base to isolate the mold. In some embodiments, this involves cutting the film 55 to create a trimmed film piece 55′, thereby providing a subassembly comprising, in sequence: the rigid substrate 180, the trimmed film piece 55′, the mold spacer 70, and the mold lid 80.

At step 930, the method further includes allowing the solution to undergo gelling in the mold, thereby forming a wet gel sheet 220′ in the mold. In one or more embodiments, the casting substrate 50, the mold spacer 70, and the mold lid 90 collectively seal, against evaporation, the solution 220 inside the mold during the gelling and aging. As noted above, the method may further include, moving the subassembly into an optional aging clamp mechanism 300, and operating the aging clamp mechanism to deliver a clamping force to the subassembly. In such embodiments, operating the aging clamp mechanism involves delivering the clamping force to the subassembly while the subassembly is in a stack together with one or more other subassemblies that each include a rigid substrate 180, a trimmed film piece 55′, a mold spacer 70, and a mold lid 80. In one or more embodiments, the subassembly is retained in the aging clamp mechanism for an aging period of 192-288 hours or even 216-264 hours.

At step 935, the method further includes removing the casting substrate 50 from the wet gel sheet 220′. In some embodiments, the method involves a wet gel sheet 220′ casted to a casting substrate 50, wherein the casting substrate comprises a film 55. Preferably, the method includes both peeling the film 55 (or trimmed film piece 55′) off the wet gel sheet 220′ and conveying the wet gel sheet onto a drying substrate 280. FIGS. 2-6 and 8A-8B illustrate non-limiting examples of equipment and components that can be used to perform the method of removing the casting substrate from wet gel sheet (step 935) as outlined in FIGS. 9-12 and according to certain embodiments described herein.

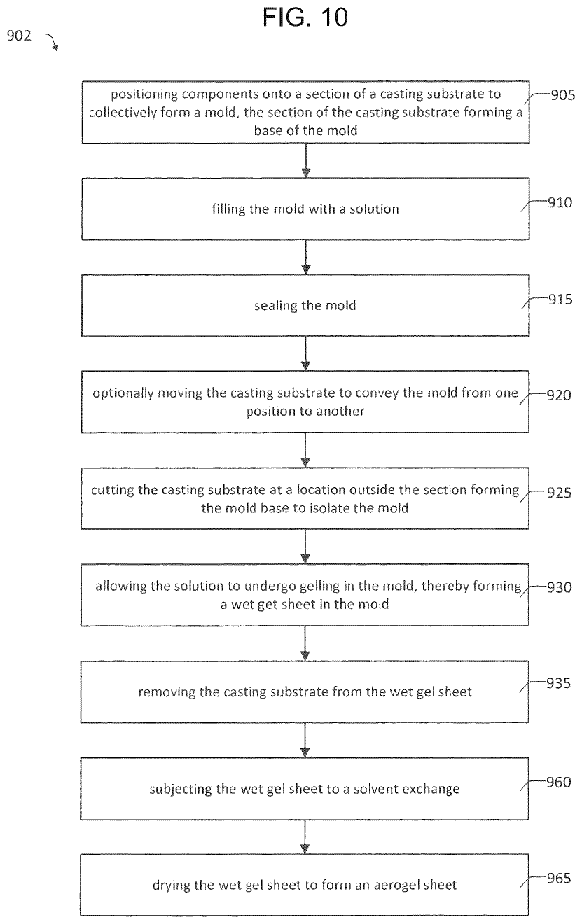

With reference to FIG. 10, an aerogel production method 902 is outlined. As previously described with respect to one or more embodiments, the method includes positioning components onto a section of a casting substrate to collectively form a mold, such that the section of the casting substrate forms a base of the mold (step 905). The method further includes filling the mold 100 with a solution 220 (step 910) and sealing the mold (915). In one or more embodiments, the method includes an optional step of moving the casting substrate 50 to convey the mold from one position to another (step 920). The method further includes cutting the casting substrate at a location outside the section forming the mold base to isolate the mold (step 925) and allowing the solution to undergo gelling in the mold, thereby forming a wet gel sheet 220′ in the mold (step 930). Once the wet gel sheet is formed, the method includes removing the casting substrate 50 from the wet gel sheet 220′ (step 935).

The aerogel production method 902 outlined in FIG. 10 further includes subjecting the wet gel sheet to a solvent exchange (step 960) and drying the wet gel sheet to form an aerogel sheet (step 965).

With respect to step 960, the solvent exchange may be preceded by allowing the solution to undergo gelling and aging in the mold, thereby forming a wet gel sheet in the mold. The subsequent solvent exchange on the wet gel sheet preferably is performed, such that prior to the solvent exchange the wet gel sheet contains water and after the solvent exchange the wet gel sheet contains a liquid solvent selected from methanol, ethanol, 2-propanol, acetone, N,N-demethylformadide and demethylsulfoxide.

At step 965, after the solvent exchange, the method further includes drying the wet gel sheet to convert the wet gel sheet into an aerogel sheet. For example, this may involve a drying operation selected from the group consisting of supercritical drying, freeze drying, and ambient drying.

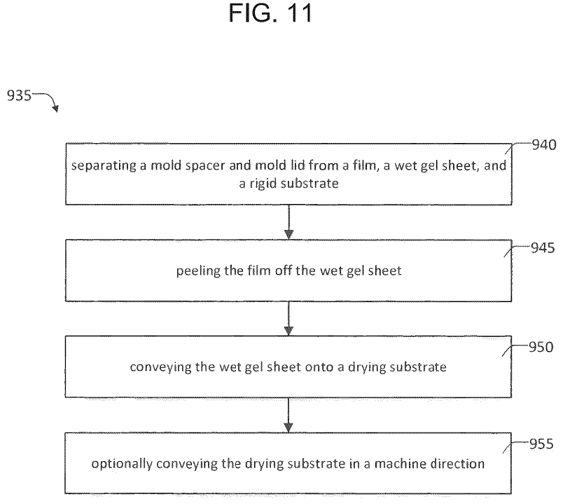

With reference to FIG. 11, a method 935 of removing a casting substrate from a wet gel sheet is outlined. In one or more embodiments, the method includes both peeling the film 55 (or trimmed film piece 55′) off the wet gel sheet 220′ and conveying the wet gel sheet onto a drying substrate 280. Non-limiting examples of useful equipment and process techniques have already been described. As noted above, the wet gel sheet may be casted to a casting substrate, which comprises a film.

At step 940, the method includes separating a mold spacer 70 and mold lid 80 from a film 55 (or trimmed film piece 55′), a wet gel sheet 220′, and a rigid substrate 180. As noted above, prior to peeling the film off the wet gel sheet, the wet gel sheet and the film preferably are part of a subassembly comprising, in sequence: a rigid substrate 180, the film 55 (or trimmed film piece 55′), a mold spacer 70, and a mold lid 80. In such cases, the method may include separating the mold spacer 70 and the mold lid 80 from the film 55 (or trimmed film piece 55′), the wet gel sheet 220′, and the rigid substrate 180 before peeling the film off the wet gel sheet. Thus, the separation step 940 may include lifting the mold spacer 70 and the mold lid 80 away from the film 55, the wet gel sheet 220′, and the rigid substrate 180, and then sliding the film and the wet gel sheet together off the rigid substrate 180.

At step 945, the method includes peeling the film off the wet gel sheet. In some embodiments, when peeling the film 55 (or trimmed film piece 55′) off the wet gel sheet 220′, the film moves in a diverging manner relative to a direction in which the wet gel sheet is travelling. For example, peeling the film off the wet gel sheet may be done while the film moves along a film conveyor 840 and/or a rotating roller 57. In such embodiments, the film may be in contact with a film conveyor 840 and/or a rotating roller 57, whereas the wet gel sheet 220′ is supported by, but does not contact, a film conveyor 840 and/or a rotating roller 57. The film 55 (or trimmed film piece 55′) may move along the film conveyor and/or rotating roller in a diverging manner relative to a direction in which the wet gel sheet 220′ is travelling. According to one or more embodiments, peeling the film off the wet gel sheet includes moving the film by winding it onto a reel.

At step 950, the method further includes conveying a wet gel sheet onto a drying substrate. The drying substrate may be received in a pan containing liquid solvent. The liquid solvent may be selected from methanol, ethanol, 2-propanol, acetone, N,N-demethylformadide and demethylsulfoxide. The drying substrate may comprise a stainless steel mesh sheet. In some embodiments, conveying the wet gel sheet onto a drying substrate involves the wet gel sheet moving along a downwardly sloped path. In one or more embodiments, for at least some period of time, the method involves simultaneously performing: (i) peeling the film 55 (or trimmed film piece 55′) off the wet gel sheet 220′ (step 945), and (ii) conveying the wet gel sheet onto the drying substrate 280 (step 950).

At optional step 955, the method further includes conveying the drying substrate in a machine direction. In one or more embodiments, method steps 945, 950, and 955 are conducted simultaneously. For example, while peeling the film off the wet gel sheet (step 945), the method may include conveying the drying substrate in a machine direction (optional step 955) while conveying the wet gel sheet onto the drying substrate (step 950).

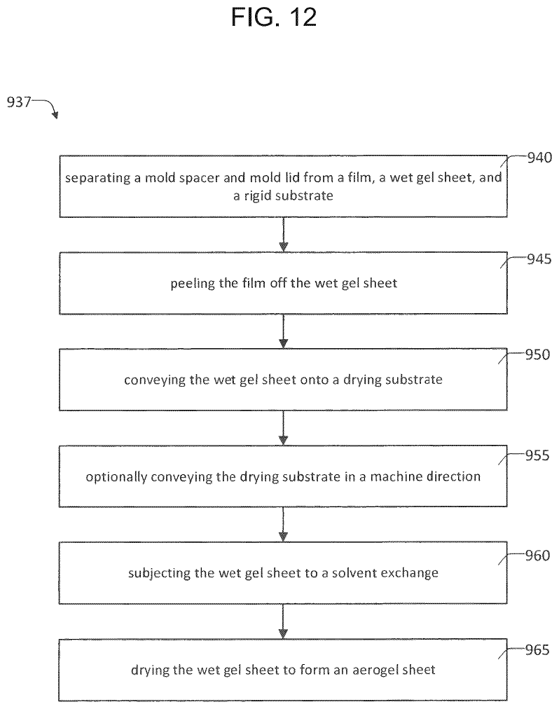

With reference to FIG. 12, an aerogel production method 937 is outlined. As previously described with respect to one or more embodiments, the method includes separating a mold spacer 70 and a mold lid 80 from a film 55 (or trimmed film piece 55′), a wet gel sheet 220′, and a rigid substrate 180 (step 940). The method further includes the steps of peeling the film off the wet gel sheet (945), conveying the wet gel sheet onto a drying substrate (step 950), and optionally conveying the drying substrate in a machine direction (optional step 955).

The aerogel production method 937 further includes subjecting the wet gel sheet to a solvent exchange (step 960) and drying the wet gel sheet to form an aerogel sheet (step 965). As previously described, step 960 may include performing a solvent exchange on the wet gel sheet, such that prior to the solvent exchange the wet gel sheet contains water and after the solvent exchange the wet gel sheet contains a liquid solvent selected from methanol, ethanol, 2-propanol, acetone, N,N-demethylformadide and demethylsulfoxide. After the solvent exchange, the method may further include drying the wet gel sheet to convert the wet gel sheet into an aerogel sheet (step 965). As previously described with respect to one or more embodiments, drying the wet gel sheet may involve supercritical drying, freeze drying, and/or ambient drying.

Various examples have been described. These and other examples are within the scope.

### Embodiments

1. An aerogel production method comprising filling a mold with a solution, wherein the mold includes a mold base defined by a casting substrate, and the casting substrate comprises a film.

2. The aerogel production method of embodiment 1 wherein, during said filling the mold with the solution, the casting substrate is maintained in a stationary position.

3. The aerogel production method of embodiment 1 or 2 wherein the mold includes a mold lid extending over a mold cavity that receives the solution during said filling the mold with the solution.

4. The aerogel production method of any one of the preceding embodiments wherein the mold includes four sidewalls defined by a mold spacer, and the mold spacer is positioned removably on top of the casting substrate.

5. The aerogel production method of any one of the preceding embodiments wherein the film has a thickness of less than 20 mils.

6. The aerogel production method of any one of the preceding embodiments wherein the solution includes water.

7. The aerogel production method of any one of the preceding embodiments wherein the film is a flexible polymer film configured to be wound about a reel.

8. The aerogel production method of any one of the preceding embodiments wherein the method includes, prior to said filling the mold with the solution, positioning a mold spacer and a mold lid onto the casting substrate to collectively form the mold.

9. The aerogel production method of embodiment 8 wherein the mold spacer and the mold lid are separate bodies, the mold spacer configured to define four sidewalls of the mold.

10. The aerogel production method of embodiment 8 or 9 wherein the casting substrate is on top of a mold staging base during said positioning the mold spacer and the mold lid onto the casting substrate.

11. The aerogel production method of any one of the preceding embodiments wherein the mold lid includes a port that is accessed during said filling the mold with the solution.

12. The aerogel production method of embodiment 11 wherein the method further includes sealing the port after said filling the mold with the solution.

13. The aerogel production method of any one of the preceding embodiments wherein the method further includes allowing the solution to undergo gelling and aging in the mold, thereby forming a wet gel sheet in the mold, and wherein the casting substrate, the mold spacer, and the mold lid collectively seal, against evaporation, the solution inside the mold during said gelling and aging.

14. The aerogel production method of any one of the preceding embodiments wherein the method further includes moving the film to convey the mold from one position to another.

15. The aerogel production method of any one of the preceding embodiments wherein the film has opposed first and second end regions that are wound respectively about first and second reels.

16. The aerogel production method of embodiment 15 wherein said moving the film to convey the mold from one position to another involves the film moving along first and second rotating rollers that are located between the first and second reels.

17. The aerogel production method of any one of the preceding embodiments wherein the casting substrate is on top of a stationary surface plate during said filling the mold with the solution.

18. The aerogel production method of any one of the preceding embodiments wherein the casting substrate is on top of a stationary mold staging base during said positioning the mold spacer and the mold lid onto the casting substrate, the casting substrate is on top of a stationary surface plate during said filling the mold with the solution, and the method includes moving the film to convey the mold from a staging position to a filling position, the mold when in the staging position being located directly above the stationary mold staging base, whereas the mold when in the filling position is located directly above the stationary surface plate.

19. The aerogel production method of any one of the preceding embodiments wherein the method further includes, during said filling the mold with the solution, clamping the mold lid, the mold spacer, and the casting substrate by operating a filling clamp mechanism.

20. The aerogel production method of embodiment 19 wherein said operating the filling clamp mechanism applies downward force onto a perimeter area of the mold lid, the perimeter area of the mold lid being directly above the mold spacer.

21. The aerogel production method of any one of the preceding embodiments wherein the method further includes moving the film to convey the mold from the filling position to a transfer position, the mold when in the transfer position being directly above a rigid substrate.

22. The aerogel production method of any one of the preceding embodiments wherein the method further includes cutting the film to create a trimmed film piece, thereby providing a subassembly comprising, in sequence: the rigid substrate, the trimmed film piece, the mold spacer, and the mold lid.

23. The aerogel production method of any one of the preceding embodiments wherein the method further includes, after said clamping the mold lid, the mold spacer, and the casting substrate, operating the filling clamp mechanism to unclamp the mold lid, the mold spacer, and the casting substrate.

24. The aerogel production method of any one of the preceding embodiments wherein the method further includes moving the subassembly into an aging clamp mechanism, and operating the aging clamp mechanism to deliver a clamping force to the subassembly.

25. The aerogel production method of any one of the preceding embodiments wherein said operating the aging clamp mechanism involves delivering the clamping force to the subassembly while the subassembly is in a stack together with one or more other subassemblies that each include a rigid substrate, a trimmed film piece, a mold spacer, and a mold lid.

26. The aerogel production method of any one of the preceding embodiments wherein the method includes allowing the solution to undergo gelling and aging in the mold, thereby forming a wet gel sheet in the mold, the subassembly being retained in the aging clamp mechanism for an aging period of 192-288 hours.

27. The aerogel production method of any one of the preceding embodiments wherein the aging period is about 216-264 hours.

28. The aerogel production method of any one of the preceding embodiments wherein the method includes allowing the solution to undergo gelling and aging in the mold, thereby forming a wet gel sheet in the mold, and subsequently performing a solvent exchange on the wet gel sheet, such that prior to the solvent exchange the wet gel sheet contains water and after the solvent exchange the wet gel sheet contains a liquid solvent selected from methanol, ethanol, 2-propanol, acetone, N,N-demethylformadide and demethylsulfoxide.

29. The aerogel production method of embodiment 28 wherein, after the solvent exchange, the method further includes drying the wet gel sheet to convert the wet gel sheet into an aerogel sheet.

30. The aerogel production method of embodiment 29 wherein said drying the wet gel sheet involves a drying operation selected from the group consisting of supercritical drying, freeze drying, and ambient drying.

31. The aerogel production method of any one of the preceding embodiments further comprising cutting the film at an integrated filling-cutting station where said filling the mold with the solution is also performed.

32. The aerogel production method of any one of the preceding embodiments wherein the mold spacer is positioned on the casting substrate and the mold lid is applied to the mold spacer by operating a filling clamp mechanism.

33. The aerogel production method of any one of the preceding embodiments wherein the casting substrate is on an upper surface of a rigid substrate during said positioning the mold spacer and the mold lid onto the casting substrate.

34. The aerogel production method of any one of the preceding embodiments wherein the casting substrate is on an upper surface of a rigid substrate during said positioning the mold spacer and the mold lid onto the casting substrate and during said filling the mold with the solution.

35. The aerogel production method of any one of the preceding embodiments wherein the filling clamp mechanism includes a filling clamp port that is accessed during said filling the mold with the solution, such that the filling clamp port is in fluid communication with the port in the mold lid during said filling the mold with the solution.

36. The aerogel production method of any one of the preceding embodiments wherein the method further includes, prior to said positioning the mold spacer and the mold lid onto the casting substrate, clamping the casting substrate on opposite sides of a rigid substrate located under the casting substrate such that the casting substrate is taut and extends along a top surface of the rigid substrate.

37. The aerogel production method of any one of the preceding embodiments wherein the method further includes, prior to said positioning the mold spacer and the mold lid onto the casting substrate, unspooling the film from a reel, extending the film along a surface of a rigid substrate, and clamping a leading end region of the film using a first film brake.

38. The aerogel production method of embodiment 37 wherein the leading end of the film is a loose end extending beyond the first film brake.

39. The aerogel production method of any one of the preceding embodiments wherein the method further includes clamping a trailing portion of the film using a second film brake, the second film brake and the first film brake being located on opposite sides of the rigid substrate.

40. The aerogel production method of any one of the preceding embodiments wherein the method further comprises cutting the film on opposite sides of the rigid substrate to create a trimmed film piece, thereby providing a subassembly comprising, in sequence: the rigid substrate, the trimmed film piece, the mold spacer, and the mold lid.

41. The aerogel production method of any one of the preceding embodiments wherein said cutting the film comprises operating first and second cutters on opposite sides of the rigid substrate.

42. An aerogel production assembly comprising a mold with a mold base defined by a casting substrate, wherein the casting substrate comprises a film.

43. The aerogel production assembly of embodiment 42 wherein the mold includes a mold lid extending over a mold cavity of the mold.

44. The aerogel production assembly of embodiment 42 or 43 wherein the mold includes four sidewalls defined by a mold spacer, and the mold spacer is positioned removably on top of the casting substrate.

45. The aerogel production assembly of any one of the preceding embodiments wherein the film has a thickness of less than 20 mils.

46. The aerogel production assembly of any one of the preceding embodiments wherein the film is a flexible polymer film.

47. The aerogel production assembly of any one of the preceding embodiments wherein the mold is filled with a solution, and the solution includes water.

48. The aerogel production assembly of any one of the preceding embodiments wherein the mold includes a mold spacer and a mold lid positioned removably on top of the film.

49. The aerogel production assembly of embodiment 48 wherein the mold spacer and the mold lid are separate bodies, and the mold spacer defines four sidewalls of the mold.

50. The aerogel production assembly of embodiment 48 or 49 wherein the film, the mold spacer, and the mold lid collectively seal, against evaporation, the solution inside the mold.

51. The aerogel production assembly of any one of the preceding embodiments wherein the mold is positioned at a filling position, the solution is on top of the film, and the film is on top of a surface plate.

52. The aerogel production assembly of any one of the preceding embodiments wherein the mold lid includes a port configured to be accessed to fill the mold with solution and thereafter sealed.

53. The aerogel production assembly of any one of the preceding embodiments further including a filling clamp mechanism, the filling clamp mechanism configured to clamp the mold lid, the mold spacer, and the film.

54. The aerogel production assembly of embodiment 53 wherein the filling clamp mechanism is configured to clamp the mold lid, the mold spacer, and the film by applying downward force onto a perimeter area of the mold lid, wherein the perimeter area of the mold lid is directly above the mold spacer.

55. The aerogel production assembly of any one of the preceding embodiments wherein the film has opposed first and second end regions that are wound respectively about first and second reels.

56. The aerogel production assembly of embodiment 55 wherein the film is in contact with first and second rotatable rollers located between the first and second reels.

57. The aerogel production assembly of any one of the preceding embodiments wherein the mold is positioned at a transfer position, and the film sits on a rigid substrate.

58. The aerogel production assembly of any one of the preceding embodiments wherein the rigid substrate comprises a glass sheet.

59. The aerogel production assembly of any one of the preceding embodiments wherein the mold is positioned at an integrated filling-cutting station configured to both fill the mold with a solution and cut the film.

60. The aerogel production assembly of any one of the preceding embodiments wherein a first cutting device is located at a front end of the integrated filling-cutting station and a second cutting device is located at a back end of the integrated filling-cutting station.

61. The aerogel production assembly of any one of the preceding embodiments wherein the mold is positioned at a filling position, the solution is on top of the film, and the film is on an upper surface of a rigid substrate.

62. The aerogel production assembly of any one of the preceding embodiments wherein the filling clamp mechanism comprises a press configured to carry the mold lid such that operating the filling clamp mechanism is configured to apply the mold lid to the mold spacer, thereby forming the mold.

63. The aerogel production assembly of any one of the preceding embodiments wherein the filling clamp mechanism further comprises a filling clamp port configured to be accessed to fill the mold with solution.

64. The aerogel production assembly of any one of the preceding embodiments further including a first and second film brake located on opposite sides of the rigid substrate and configured to clamp the film on opposite sides of the rigid substrate, such that the film extends along a top surface of the rigid substrate.

65. The aerogel production assembly of any one of the preceding embodiments wherein the film has a leading portion and a trailing portion, the trailing portion wound about a reel and the leading portion clamped using a film brake, such that the leading portion of the film comprises a loose end extending beyond the film brake.

66. The aerogel production assembly of any one of the preceding embodiments further comprising a first cutting device and a second cutting device located on opposite sides of the rigid substrate and configured to cut the clamped film on opposite sides of the rigid substrate to form a subassembly comprising, in sequence: the rigid substrate, the trimmed film piece, the mold spacer, and the mold lid.

67. The aerogel production assembly of any one of the preceding embodiments wherein the first cutting device and the second cutting device are configured to cut the film, thereby forming a loose end of the film.

68. The aerogel production assembly of any one of the preceding embodiments wherein the loose end of the film extends about 3 to 9 inches beyond the mold.

69. The aerogel production assembly of any one of the preceding embodiments wherein the first cutting device and the second cutting device each comprise at least one blade configured to cut the film.

70. An aerogel production assembly comprising a film and a film handling system, the film configured to serve as a casting substrate, and the film handling system configured to provide the film at a filling station of the aerogel production assembly.

71. The aerogel production assembly of embodiment 70 wherein the filling station is at a location where a wet gel precursor solution is delivered downwardly into a mold having a mold base defined by the film.

72. The aerogel production assembly of embodiment 70 or 71 further comprising at least one blade configured to cut the film.

73. The aerogel production assembly of any one of the preceding embodiments wherein the film has a thickness of less than 20 mils.

74. The aerogel production assembly of any one of the preceding embodiments wherein the film has free leading and trailing ends, rather than being a continuous loop.

75. The aerogel production assembly of any one of the preceding embodiments wherein the film has a configuration that is entirely sheet-like, with no edges that define mold sidewalls.

76. The aerogel production assembly of any one of the preceding embodiments wherein the film handling system includes a supply reel, and the film has a trailing end region wound about the supply reel.

77. The aerogel production assembly of any one of the preceding embodiments wherein the film handling system includes first and second reels, the film has leading and trailing end regions wound respectively about the first and second reels, and the film handling system further includes first and second rotatable rollers, the first and second rotatable rollers configured to contact the film while rotating and being located between the first and second reels.

78. The aerogel production assembly of any one of the preceding embodiments further including a filling clamp mechanism, the filling clamp mechanism configured to clamp a mold having a mold base defined by the film.

79. The aerogel production assembly of embodiment 78 wherein the filling clamp mechanism is configured to clamp the mold by applying downward force onto a perimeter area of the mold.

80. The aerogel production assembly of embodiment 78 or 79 wherein the filling clamp mechanism is configured to clamp the mold while leaving a top area of the mold accessible for filling the mold with solution.

81. The aerogel production assembly of any one of the preceding embodiments wherein the film, when operatively positioned, has a span extending over and along a top surface of a surface plate.

82. The aerogel production assembly of any one of the preceding embodiments wherein the film, when operatively positioned, has a span extending through a cutting station, the cutting station including at least one blade configured to cut the film.

83. The aerogel production assembly of any one of the preceding embodiments further including an aging clamp mechanism, the aging clamp mechanism having a chamber configured to receive a batch of molds each containing a solution that undergoes gelling and aging while the batch of molds is in the chamber of the aging clamp mechanism.

84. The aerogel production assembly of embodiment 83 wherein the chamber of the aging clamp mechanism is configured to receive the batch of molds in a stacked arrangement wherein the molds are stacked one on top of another.

85. The aerogel production assembly of embodiment 83 or 84 wherein the aging clamp mechanism includes a clamp configured to deliver clamping force to the molds of the batch when they are received in the chamber in the stacked arrangement.

86. The aerogel production assembly of any one of the preceding embodiments further including a solvent exchange station and a drying station, wherein the drying station is configured to perform a drying operation selected from the group consisting of supercritical drying, freeze drying, and ambient drying.

87. The aerogel production assembly of embodiment 86 wherein the drying station comprises a supercritical drying chamber.

88. The aerogel production assembly of any one of the preceding embodiments wherein the filling station is an integrated filling-cutting station configured to both fill the mold and cut the film.

89. The aerogel production assembly of embodiment 88 wherein a first cutting device is located at a front end of the integrated filling-cutting station and a second cutting device is located at a back end of the integrated filling-cutting station.

90. The aerogel production assembly of any one of the preceding embodiments wherein the film, when operatively positioned, has a span extending over and along a top surface of a rigid substrate.

91. An aerogel production assembly comprising an aging clamp mechanism, the aging clamp mechanism configured to deliver clamping force to a batch of molds.

92. The aerogel production assembly of embodiment 91 wherein the aging clamp mechanism has a chamber configured to receive the molds of the batch in a stacked arrangement wherein the molds are stacked one on top of another.

93. The aerogel production assembly of embodiment 91 or 92 wherein the aging clamp mechanism includes a clamp at an upper region of the chamber, the clamp configured to deliver the clamping force to the batch of molds.

94. The aerogel production assembly of any one of the preceding embodiments wherein the clamp is adjacent a ceiling of the chamber so as to be positioned to bear against an uppermost one of the molds in the stacked arrangement.

95. The aerogel production assembly of any one of the preceding embodiments wherein the aging clamp mechanism is in a loaded, clamped position, such that the molds of the batch are received in the chamber in the stacked arrangement with the clamp bearing against the uppermost one of the molds in the stacked arrangement.

96. The aerogel production assembly of any one of the preceding embodiments wherein the stacked arrangement is characterized by the molds being stacked directly one on top of another.

97. The aerogel production assembly of any one of the preceding embodiments wherein each of the molds includes, in sequence from bottom to top, a rigid substrate, a mold spacer, and a mold lid.

98. The aerogel production assembly of embodiment 97 wherein the mold spacer and the mold lid are separate bodies, and the mold spacer defines mold sidewalls.

99. The aerogel production assembly of any one of the preceding embodiments wherein each of the molds includes, in sequence from bottom to top, a rigid substrate, a film, a mold spacer, and a mold lid.

100. The aerogel production assembly of any one of the preceding embodiments wherein each of the molds contains a wet gel sheet.

101. An aerogel production method involving a wet gel sheet casted to a casting substrate, wherein the casting substrate comprises a film, wherein the method includes both peeling the film off the wet gel sheet and conveying the wet gel sheet onto a drying substrate.

102. The aerogel production method of embodiment 101 wherein the drying substrate is in a pan containing a liquid solvent.

103. The aerogel production method of embodiment 101 or 102 wherein the liquid solvent is selected from methanol, ethanol, 2-propanol, acetone, N,N-demethylformadide and demethylsulfoxide.

104. The aerogel production method of any one of the preceding embodiments wherein the drying substrate comprises a stainless steel mesh sheet.

105. The aerogel production method of any one of the preceding embodiments wherein, during said peeling the film off the wet gel sheet, the method includes conveying the drying substrate in a machine direction while simultaneously conveying the wet gel sheet onto the drying substrate.

106. The aerogel production method of embodiment 105 wherein said conveying the wet gel sheet onto the drying substrate involves the wet gel sheet moving along a downwardly sloped path.

107. The aerogel production method of any one of the preceding embodiments wherein, during a period of time, the method involves simultaneously performing: (i) said peeling the film off the wet gel sheet, and (ii) said conveying the wet gel sheet onto the drying substrate.

108. The aerogel production method of any one of the preceding embodiments wherein, during said peeling the film off the wet gel sheet, the film moves in a diverging manner relative to a direction in which the wet gel sheet is travelling.

109. The aerogel production method of any one of the preceding embodiments wherein said peeling the film off the wet gel sheet is done while the film moves along a rotating roller.

110. The aerogel production method of any one of the preceding embodiments wherein, during said peeling the film off the wet gel sheet, the film is in contact with the rotating roller whereas the wet gel sheet is supported by, but does not contact, the rotating roller.

111. The aerogel production method of any one of the preceding embodiments wherein, during said peeling the film off the wet gel sheet, the film moves along the rotating roller in a diverging manner relative to a direction in which the wet gel sheet is travelling.

112. The aerogel production method of any one of the preceding embodiments wherein said peeling the film off the wet gel sheet includes moving the film by winding it onto a reel.

113. The aerogel production method of any one of the preceding embodiments wherein, prior to said peeling the film off the wet gel sheet, the wet gel sheet and the film are part of a subassembly comprising, in sequence: a rigid substrate, the film, a mold spacer, and a mold lid, and wherein the method includes separating the mold spacer and the mold lid from the film, the wet gel sheet, and the rigid substrate before said peeling the film off the wet gel sheet.

114. The aerogel production method of embodiment 113 wherein said separating the mold spacer and the mold lid from the film, the wet gel sheet, and the rigid substrate includes lifting the mold spacer and the mold lid away from the film, the wet gel sheet, and the rigid substrate, and the method further includes sliding the film and the wet gel sheet together off the rigid substrate.

115. The aerogel production method of any one of the preceding embodiments further including performing a solvent exchange on the wet gel sheet, such that prior to the solvent exchange the wet gel sheet contains water and after the solvent exchange the wet gel sheet contains a liquid solvent selected from methanol, ethanol, 2-propanol, acetone, N,N-demethylformadide and demethylsulfoxide.

116. The aerogel production method of embodiment 115 wherein, after the solvent exchange, the method further includes drying the wet gel sheet to convert the wet gel sheet into an aerogel sheet.

117. The aerogel production method of embodiment 116 wherein said drying the wet gel sheet involves supercritical drying.

118. The aerogel production method of any one of the preceding embodiments wherein said conveying the wet gel sheet onto the drying substrate involves the wet gel sheet moving along a conveyor belt.

119. The aerogel production method of embodiment 118 wherein said peeling the film off the wet gel sheet is done while the conveyor belt moves along a rotating roller.

120. The aerogel production method of embodiment 118 or 119 wherein, during said peeling the film off the wet gel sheet, a leading end region of the film is attached to the conveyor belt.

121. The aerogel production method of any one of the preceding embodiments wherein the film is attached to the conveyor belt with an adhesive.

1. An aerogel production method involving a wet gel sheet casted to a casting substrate, wherein the casting substrate comprises a film, wherein the method includes both peeling the film off the wet gel sheet and conveying the wet gel sheet onto a drying substrate.

2. The aerogel production method of claim 1 wherein the drying substrate is in a pan containing a liquid solvent.

3. The aerogel production method of claim 2 wherein the liquid solvent is selected from methanol, ethanol, 2-propanol, acetone, N,N-demethylformadide and demethylsulfoxide.

4. The aerogel production method of claim 1 wherein the drying substrate comprises a stainless steel mesh sheet.

5. The aerogel production method of claim 1 wherein, during said peeling the film off the wet gel sheet, the method includes conveying the drying substrate in a machine direction while simultaneously conveying the wet gel sheet onto the drying substrate.

6. The aerogel production method of claim 5 wherein said conveying the wet gel sheet onto the drying substrate involves the wet gel sheet moving along a downwardly sloped path.

7. The aerogel production method of claim 1 wherein, during a period of time, the method involves simultaneously performing: (i) said peeling the film off the wet gel sheet, and (ii) said conveying the wet gel sheet onto the drying substrate.

8. The aerogel production method of claim 1 wherein, during said peeling the film off the wet gel sheet, the film moves in a diverging manner relative to a direction in which the wet gel sheet is travelling.

9. The aerogel production method of claim 1 wherein said peeling the film off the wet gel sheet is done while the film moves along a rotating roller.

10. The aerogel production method of claim 9 wherein, during said peeling the film off the wet gel sheet, the film is in contact with the rotating roller whereas the wet gel sheet is supported by, but does not contact, the rotating roller.

11. The aerogel production method of claim 9 wherein, during said peeling the film off the wet gel sheet, the film moves along the rotating roller in a diverging manner relative to a direction in which the wet gel sheet is travelling.

12. The aerogel production method of claim 1 wherein said peeling the film off the wet gel sheet includes moving the film by winding it onto a reel.

13. The aerogel production method of claim 1 wherein, prior to said peeling the film off the wet gel sheet, the wet gel sheet and the film are part of a subassembly comprising, in sequence: a rigid substrate, the film, a mold spacer, and a mold lid, and wherein the method includes separating the mold spacer and the mold lid from the film, the wet gel sheet, and the rigid substrate before said peeling the film off the wet gel sheet.

14. The aerogel production method of claim 13 wherein said separating the mold spacer and the mold lid from the film, the wet gel sheet, and the rigid substrate includes lifting the mold spacer and the mold lid away from the film, the wet gel sheet, and the rigid substrate, and the method further includes sliding the film and the wet gel sheet together off the rigid substrate.

15. The aerogel production method of claim 1 further including performing a solvent exchange on the wet gel sheet, such that prior to the solvent exchange the wet gel sheet contains water and after the solvent exchange the wet gel sheet contains a liquid solvent selected from methanol, ethanol, 2-propanol, acetone, N,N-demethylformadide and demethylsulfoxide.

16. The aerogel production method of claim 15 wherein, after the solvent exchange, the method further includes drying the wet gel sheet to convert the wet gel sheet into an aerogel sheet.

17. The aerogel production method of claim 16 wherein said drying the wet gel sheet involves supercritical drying.

18. The aerogel production method of claim 1 wherein said conveying the wet gel sheet onto the drying substrate involves the wet gel sheet moving along a conveyor belt.

19. The aerogel production method of claim 18 wherein said peeling the film off the wet gel sheet is done while the conveyor belt moves along a rotating roller.

20. The aerogel production method of claim 18 wherein, during said peeling the film off the wet gel sheet, a leading end region of the film is attached to the conveyor belt.

21. The aerogel production method of claim 20 wherein the film is attached to the conveyor belt with an adhesive.
